(19) United States
(12) Patent Application Publication
(10) Pub. No.: US 2003/0222982 A1
(43) Pub. Date: Dec. 4, 2003

(54) Integrated video/data information system and method for application to commercial vehicles to enhance driver awareness

(76) Inventors: Majil M. Hamdan, North Olmsted, OH (US); Mark W. Waltz, Broadview Heights, OH (US); Dennis M. Losh, Vermillion, OH (US); David J. Pfefferl, Broadview Heights, OH (US); Ken A. Grolle, Elyria, OH (US)

Correspondence Address: CALFEE HALTER & GRISWOLD, LLP, 800 SUPERIOR AVENUE, SUITE 1400, CLEVELAND, OH, 44114, US

(21) Appl. No.: 10/393,180

(22) Filed: Mar. 20, 2003

Related U.S. Application Data
(60) Provisional application No. 60/368,404, filed on Mar. 28, 2002.
(60) Provisional application No. 60/368,267, filed on Mar. 28, 2002.
(60) Provisional application No. 60/368,428, filed on Mar. 28, 2002.
(60) Provisional application No. 60/368,266, filed on Mar. 28, 2002.
(60) Provisional application No. 60/368,429, filed on Mar. 28, 2002.
(60) Provisional application No. 60/390,075, filed on Jun. 20, 2002.
(60) Provisional application No. 60/401,405, filed on Aug. 5, 2002.
(60) Provisional application No. 60/401,406, filed on Aug. 5, 2002.
(60) Provisional application No. 60/402,265, filed on Aug. 8, 2002.
(60) Provisional application No. 60/404,723, filed on Aug. 20, 2002.
(60) Provisional application No. 60/408,529, filed on Sep. 4, 2002.

(51) Int. Cl. H04N 7/18

(52) U.S. Cl. 348/148

(57) ABSTRACT

An integrated video/data information system for use on-board a commercial vehicle comprises a digital integrated data bus for conveying among bus compatible camera and display modules coupled to the bus video and data information in a digital format based on a predetermined bus protocol. Each camera module is operative to transmit, upon command, over the bus the image data in a digital format compatible with the predetermined bus protocol. Each display module is operative to receive from the bus, upon command, image data originating from a selected camera module, and to display the image data on a display monitor thereof. The system includes a bus master module coupled to the integrated data bus for transmitting commands over the bus to the camera and display modules. Such commands comprise a first command for directing a selected camera module to transmit image data thereof over the bus, and a second command for directing a selected display module to receive image data corresponding to the selected camera module from the bus and to display the received image data on the display monitor thereof. The first and second commands may be transmitted based on the operational status of the vehicle.

Provisional Application No. 60/408,529, entitled “IBM PC Keyboard-to-JBUS Converter” and filed Sep. 4, 2002.

### BACKGROUND OF THE INVENTION

The present invention is directed to vehicle vision and information systems for driver awareness and operation, in general, and more particularly, to an integrated video/data information system and method for sharing information among resources in a commercial vehicle to enhance driver awareness and operational capability.

The industry covering commercial vehicles, like trucks, for example, has identified that drivers are confronted with “information overload” due to the inadequate sharing of information among the various systems or resources on-board the vehicle. Each resource typically has its own dedicated camera or cameras, display, input/output (I/O) switches, warning messages, audio and visual indicators, and the like. The voluminous amount of information broadcast to the driver from the various individual resources overwhelms the driver and causes driver confusion over vehicle status and information priority. This driver confusion may affect operational behavior and lead to reduced safety. In addition, the wiring together of the on-board components of each individual resource causes wiring complexity, adds to the cost of the overall vehicle, and results in reduced physical real estate to accommodate all of the individual components inside the vehicle.

In general, some vehicle vision systems require driver intervention to select the camera which pertains to the vehicle maneuver in progress. Other vision systems automatically perform a pre-defined camera-to-display selection. In both cases, the cameras are hardwired to signals inside the vehicle and image selection is generally not alterable. Also, these systems are typically standalone and do not interact with any other sub-systems on the vehicle. Such systems also compete for valuable real-estate within the vehicle and add to driver distraction.

Moreover, the National Highway Transportation Safety Agency (NHTSA) has indicated a desire to reduce accidents involving commercial vehicles by as much as 50% by the year 2008. To support this effort, the industry is proposing vision, audio and data recording systems in the vehicles to record video scenes from cameras disposed about the vehicle, driver conversations and accident sounds and data representative of the status of the vehicle, respectively, for a predetermined most recent amount of time for accident reconstruction and analysis. Current commercial vehicle resources communicate over multiple, independent communication buses, like the J1939, J1587, J2497 and the like, for example. Data is accessed from these buses to provide control, diagnostics and monitoring of the various vehicle resources. In addition, pertinent information acquired from the vehicle's communication buses may be stored on a data recorder. However, in order to provide for a true depiction of an accident scene, the video and audio of the accident should be captured and stored time synchronized with the monitored data. The vehicle's J buses alone are not conducive for providing time synchronized visual, audio and data information to a recording medium.

The present invention overcomes the aforementioned drawbacks and provides an integrated video/data/voice information system for sharing information among resources in a commercial vehicle, and prioritizing displayed messages in order to reduce “information overload” and enhance driver awareness and operational capability, reduce wiring complexity and cost, render more physical real estate available inside the vehicle for additional resources, and provide for the recording of time synchronized visual, audio and data information on a recording medium for accident reconstruction and analysis.

### SUMMARY OF THE INVENTION

In accordance with one aspect of the present invention, an integrated video/data information system for use on-board a commercial vehicle comprises: a digital integrated data bus for conveying among bus modules coupled to the bus video and data information in a digital format based on a predetermined bus protocol; a plurality of bus compatible camera modules coupled to the integrated data bus, each camera module of the plurality comprising a camera for generating image data representative of a view thereof, each camera module operative as a bus module for transmitting, upon command, over the bus the image data in a digital format compatible with the predetermined bus protocol; at least one bus compatible display module coupled to the integrated data bus, each display module comprising a display monitor for displaying image data for viewing by an operator, each display module operative as a bus module to receive from the bus, upon command, image data originating from a selected camera module of the plurality, and to display the image data on the display monitor thereof; and a bus master module coupled to the integrated data bus for transmitting commands over the bus to the plurality of camera modules and the at least one display module, the commands comprising a first command for directing a selected camera module of the plurality to transmit image data thereof over the bus, and a second command for directing a selected display module of the at least one display module to receive image data corresponding to the selected camera module from the bus and to display the received image data on the display monitor thereof.

In accordance with another aspect of the present invention, a text overlay module is disposeable on-board a commercial vehicle and is coupleable between a display monitor and at least one existing communication bus of the vehicle for overlaying text messages onto image data for display on the display monitor. The module comprises: a bus interface circuit coupled to the at least one communication bus for receiving vehicle data representative of fault conditions and operational measurement and status data from the at least one communication bus; a microcontroller coupled to the bus interface circuit and operative to respond to the received fault condition and operational data; a memory for storing text messages corresponding to fault conditions and operational data of the vehicle; and the microcontroller responsive to fault condition and operational data received from the at least one communication bus to access corresponding text messages from the memory and to overlay the text messages onto image data for display on the display monitor.

In accordance with yet another aspect of the present invention, a communication bus module is operative to communicate alarm and operational data over at least one existing communication bus on-board a commercial vehicle. The module comprises: a bus interface circuit coupled to the at least one communication bus for transmitting alarm and operational data over the at least one communication bus; a microcontroller coupled to the bus interface circuit and operative to control the transmission of alarm and operational data over the at least one communication bus; a first interface circuit coupled to the microcontroller for receiving data signals representative of an operational status of the vehicle and for passing the operational status data to the microcontroller; a second interface circuit coupled to the microcontroller for receiving and digitizing sensor signals from a plurality of on-board vehicle sensors operative to measure parameters of the vehicle and for passing the digitized sensor signals to the microcontroller; a memory for storing thresholds corresponding to the sensor signals, the thresholds being based on the vehicle parameter being measured by the corresponding sensor; the microcontroller operative to convert the operational status data into first bus messages and to control the transmission of the first bus messages over the at least one communication bus; and

the microcontroller further operative to generate data representative of alarm conditions determined from the digitized sensor signals and their corresponding thresholds, to convert the alarm condition data into second bus messages and to control the transmission of the second bus messages over the at least one communication bus.

In accordance with yet another aspect of the present invention, a diagnostic system for use on a commercial vehicle utilizes an at least one existing on-board communication bus and an existing on-board vision system including a camera for generating image data representative of a view thereof, and a display monitor for displaying the camera image data on a screen thereof, the vehicle including a plurality of electronic control units (ECUs) for monitoring the fault status of corresponding resources, the plurality of ECUs being coupled to the at least one communication bus for conveying fault condition and diagnostic data thereover. The system comprises: a display generator unit including: a microcontroller; a bus interface circuit coupled between the microcontroller and the at least one communication bus for receiving fault condition and diagnostic data from the communication bus and passing the received data to the microcontroller; a text overlay circuit coupled between the camera and display monitor and governed by the microcontroller for overlaying text messages onto the image data of the camera to form composite image data and for transmitting the composite image data to the display monitor for display thereon; and a memory coupled to the microcontroller for storing text messages and text menu screens corresponding to the fault conditions; and a communication bus module coupled to the at least one communication bus for receiving display command signals from a user interface and transmitting the display command signals over the at least one communication bus, the display command signals being received by the bus interface circuit and passed to the microcontroller for use in controlling the display of text messages and text menu screens on the display monitor.

In accordance with yet another aspect of the present invention, a bus compatible converter circuit is coupled between an integrated data bus having a predetermined bus protocol and a camera for generating an NTSC image signal representative of a view thereof. The converter circuit comprises: a first circuit coupled to the camera for converting the NTSC image signal into compressed digital video data representative thereof, a second circuit coupled between the first circuit and the bus for transmitting the compressed digital video data over the bus in a format compatible with the predetermined bus protocol; and a controller coupled to the first and second circuits for coordinating the operations of the first and second circuits.

In accordance with yet another aspect of the present invention, a bus compatible converter circuit is coupled between an integrated data bus having a predetermined bus protocol and a display monitor for displaying an NTSC,image signal on a screen thereof. The converter circuit comprises: a first circuit coupled to the bus for receiving from the bus compressed digital video data representative of the NTSC image signal and in a format compatible with the predetermined bus protocol; a second circuit coupled between the first circuit and the display monitor for converting the compressed digital video data into the NTSC image signal representative thereof for display on the monitor screen; and a controller coupled to the first and second circuits for coordinating the operations of the first and second circuits.

In accordance with yet another aspect of the present invention, an integrated video/data information system for use on-board a commercial vehicle including at least one existing communication bus comprises: a plurality of cameras, each camera for generating an image signal representative of a view thereof; a plurality of display monitors, each display monitor for displaying a camera generated image signal for viewing by an operator; a matrix of switches disposed between the plurality of cameras and the plurality of display monitors; a switch controller coupled to the matrix of switches for controlling the switches to connect the image signal from at least one camera to at least one display monitor for display on a viewing screen thereof, the switch controller being coupled to the at least one communication bus for receiving data therefrom; and a bus communication module coupled to the at least one communication bus, the module operative to receive data signals representative of an operational status of the vehicle and to transmit the operational status data over the at least one communication bus, the switch controller operative to receive the operational status data from the at least one communication bus and to control the switches of the matrix based on the operational status data.

In accordance with yet another aspect of the present invention, a keyboard user interface for use on-board a commercial vehicle for communicating over at least one existing communication bus of the vehicle comprises: a keyboard comprising a multiplicity of character keys for selection by a user and for generating a coded digital word representative of a user selected character key thereof; and a communication interface circuit coupled between the keyboard and the at least one communication bus, the communication interface circuit operative to receive the coded digital word, to convert the received coded digital word into a character message compatible with the at least one communication bus, and to transmit the character message over the at least one communication bus of the vehicle.

In accordance with a further aspect of the present invention, a method of communicating integrated video/data information on-board a commercial vehicle comprises the steps of: generating from each of a plurality of bus compatible camera modules image data representative of a corresponding view thereof; transmitting a first command over a digital integrated data bus to a selected camera module of the plurality to direct the selected camera module to transmit image data over the data bus in a digital format compatible with a predetermined bus protocol; transmitting a second command over the digital integrated data bus to a bus compatible display module to direct the display module to receive from the data bus in accordance with the predetermined bus protocol the digitally formatted image data originating from the selected camera module and to display the image data; and transmitting the first and second commands based on an operational status of the commercial vehicle.

### BRIEF DESCRIPTION OF THE DRAWINGS

FIG. 1 is a block diagram schematic of an exemplary integrated video/data information system for application to commercial vehicles suitable for embodying one aspect of the present invention.

FIG. 2 is a block diagram schematic of an exemplary gateway electronic control unit (ECU) embodiment suitable for use in the system embodiment of FIG. 1.

FIG. 3 is a block diagram schematic of an exemplary orchestrator or bus master module embodiment suitable for use in the system embodiment of FIG. 1.

FIG. 4 is a block diagram schematic of an alternate embodiment of the integrated video/data information system depicted in FIG. 1.

FIG. 5 is a block diagram schematic of an exemplary embodiment of a DV-NTSC converter circuit suitable for use in the system embodiment of FIG. 4.

FIG. 6 is a block diagram schematic of an exemplary embodiment of a NTSC-DV converter circuit suitable for use in the system embodiment of FIG. 4.

FIG. 7 is a block diagram schematic of an exemplary embodiment of a smart switch suitable for use in the system embodiment of FIG. 4.

FIG. 8 is a block diagram schematic of an exemplary embodiment of a text/graphics overlay circuit suitable for use in the system embodiment of FIG. 4.

FIG. 9 depicts an exemplary look-up table suitable for use in programming the orchestrator module of the system embodiments of FIGS. 1 and 4.

FIG. 10 is an exemplary program flow chart suitable for use in programming the orchestrator module of the system embodiments of FIGS. 1 and 4.

FIG. 11 is an exemplary program flow chart suitable for use in programming the gateway module of the system embodiments of FIGS. 1 and 4.

FIG. 12 is a block diagram schematic of an exemplary diagnostics display system suitable for embodying another aspect of the present invention.

FIGS. 13-18 are screen display illustrations for use in exemplifying the operations of the system embodiment of FIG. 12.

FIG. 19 is a block diagram schematic of an alternate embodiment of an integrated video/data information system for exemplifying yet another aspect of the present invention.

FIG. 20 is a circuit schematic of an exemplary electronic switch suitable for use in the system embodiment of FIG. 19.

FIG. 21 depicts an exemplary look-up table suitable for use in programming a controller of the embodiment of FIG. 19.

FIG. 22 is a block diagram schematic of an alternate embodiment of the integrated system depicted in FIG. 19.

FIG. 23 is a block diagram schematic of another alternate embodiment of the integrated system depicted in FIG. 19.

FIG. 24 is a block diagram schematic of yet another alternate embodiment of the integrated system depicted in FIG. 19.

FIG. 25 is a block diagram schematic of an exemplary keyboard user interface unit in accordance with another aspect of the present invention.

FIG. 26 depict synchronized waveforms of a clock and data exemplifying the character transmissions of an exemplary keyboard suitable for use in the embodiment of FIG. 25.

### DETAILED DESCRIPTION OF THE INVENTION

Conceptually, one aspect of the present invention is embodied by a system disposed on-board a commercial vehicle and based on a distributed architecture which enhances the driver's awareness and ability to operate the commercial vehicle, like a trailer truck, for example. It does this by increasing the driver's view of the vehicle's surroundings during operation thereof through the use of multiple video and night vision (NV) cameras disposed about the vehicle and one or more monitors located in the cab of the vehicle for convenient viewing by the driver. The system also has the ability to integrate any subsystem or resource installed on the vehicle which has access to existing data transmission buses distributed throughout the vehicle, better known as JBUSes (J1939 CAN, J1587/J1708 Diagnostics, and J2497 PLC). The system further has the ability to prioritize the video and data presented to the driver over the one or more display monitors by controlling the amount of information displayed, the time information is displayed, and the selection of the actual camera image or images displayed to the driver, for example. The matching of camera-to-display monitor is controlled intelligently through the system's knowledge of certain events and selector switch inputs as will become more evident from the following description. The system utilizes a device, referred to as a smart switch, to read switch inputs, decipher them, and transmit their status onto the JBUSes of the vehicle, and a listening device, referred to as a gateway, to receive information and command messages from the JBUSes of the vehicle.

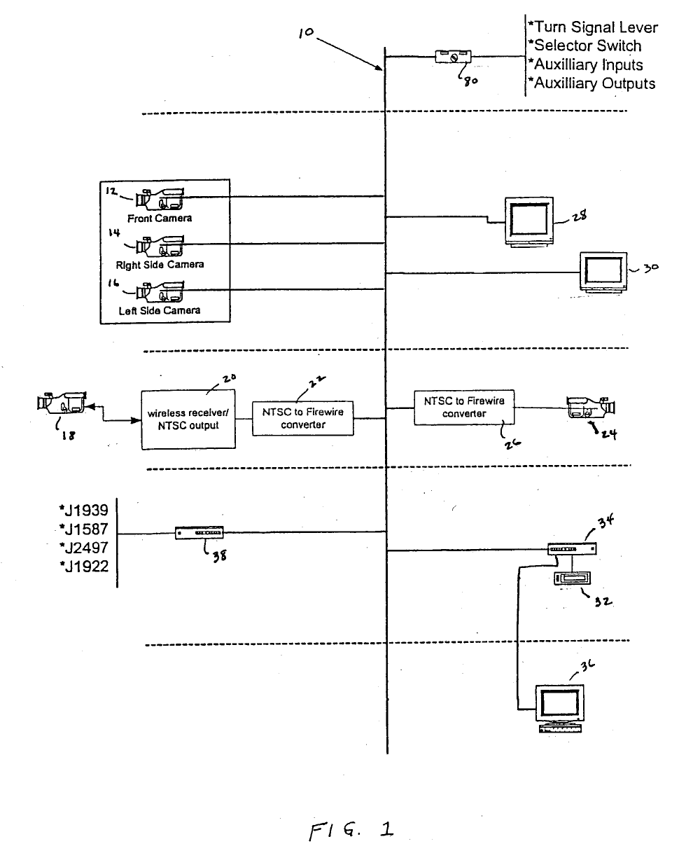

FIG. 1 is a block diagram schematic of one embodiment of the inventive system which is configured around an integrated data bus (IDB) 10 which may be designed using the IEEE-1394 standard which is referred to in the industry as the FireWire™ bus, for example. The IDB 10 is a high performance, digital serial bus and may have transmission rates on the order of 100-400 megabits per second (Mb/s). Because the FireWire bus has a standard communication protocol, many electronic manufactures have designed and marketed “off-the-shelf” integrated circuits (ICs) programmed to interface their products and the products of others to the bus. Thus, it has become convenient in the industry to communicate over the FireWire bus. Due to the high transmission rates, synchronization of data and video image(s) in real time over the bus 10 is a practical reality. Also, since data transmission over the bus 10 is digital in nature, it may be conveniently stored for later retrieval as will be better understood from the description below.

Referring to FIG. 1, a plurality of video cameras may be disposed about the periphery of the commercial vehicle and coupled to the bus 10. For example, a front mounted video camera 12, a right side mounted video camera 14 and a left side mounted video camera 16 may be coupled to the bus 10. All of the cameras 12, 14 and 16 may be FireWire bus compatible cameras which means that the cameras are equipped with internal conversion circuitry to convert the National Television Standard Committee (NTSC) raster scan video image camera signal to a compressed digital video (DV) format suitable for transmission over the IDB bus 10. Each internal camera circuitry will also include programmed bus protocol circuitry to interface the DV image data over the bus 10 when commanded to do so. A code identifying the source camera may be transmitted with each DV image transmission over the bus 10. Each of the bus compatible cameras 12, 14 and 16 may be of the type manufactured by Voyager bearing model no. AOC-100B, for example.

In addition, a rear mounted video camera 18 may either be coupled directly to the bus 10 or transmit a wireless NTSC video image signal at approximately 2.4 Gigahertz (GHz), for example. If wireless transmission is used, then a standard television receiver 20 may be included for receiving the NTSC video image signal and passing it along to a NTSC-to-FireWire converter circuit 22 which is coupled to the IDB bus 10. The converter circuit 22 is operational to convert the National Television Standard Committee (NTSC) raster scan video image camera signal to a compressed digital video (DV) format suitable for transmission over the IDB bus 10 and to transmit the DV image data over the bus 10 when commanded to do so. A code identifying the source camera may be transmitted by the converter 22 with each DV image transmission over the bus 10. The wireless rear mounted camera 18 may be of the type manufactured by X10 bearing model no. Xcam2, for example.

The system may also include one or more night vision (NV) cameras 24 mounted on the vehicle for night time viewing of the vehicle surroundings without the benefit of sunlight, i. e. in the darkness. Each NV camera 24 may be coupled to the bus 10 utilizing a NTSC-to-FireWire converter circuit 26 which may be the same as or similar to the converter 22 described herein above. Each NV camera may be of the type manufactured by Raytheon under the part no. 5008214, for example.

Also included in the system are a plurality of monitors which may be mounted in the cabin of the commercial vehicle for convenient viewing by the driver. The plurality may include at least one flat panel display monitor 28 and perhaps a heads up or heads down display (HUD/HDD) 30. In the embodiment of FIG. 1, both displays 28 and 30 are FireWire bus compatible and are coupled directly to the bus 10. Being FireWire bus compatible for a monitor is similar to being FireWire bus compatible the cameras 12, 14 and 16 described above except that a conversion from DV image data accessed from the bus 10 to NTSC video raster scan format is performed in the monitor before the image is presented to the screen thereof. The monitors 28 and 30 are operational to display video and NV images through commands received over the bus 10 as will become more evident from the following description. The flat panel monitors 28 may include a 6.8 inch display screen and be of the type manufactured by Adiovox Specialized Applications under the model no. AOM 681, for example. The HUD/HDD displays 30 may be of the type manufactured by Raytheon bearing part no. 3265438-1, for example.

Since the bus 10 accommodates seemingly concurrent digital data and compressed digital video and audio transmission at high speeds, it permits digital storage of such data, audio and video image(s) synchronized to each other in real time for later retrieval. A mass storage device 32 is included in the system and operated to store the data in a synchronized format. The device 32 may be comprised of a hard drive, a solid state memory, a high density disk drive and/or a digital video disk drive, for example. Preferably, the device 32 comprises a high speed mass storage device of the type manufactured by IBM bearing a model denoted as Microdrive, for example. To manage the digital storage of data on channels of the storage media of the device 32, a BIM (Blue Box Information Manager) device 34 is coupled between the bus 10 and storage device 32. The BIM 34 may be event driven under commands received from the bus 10 to store in a real time synchronized format digital data, video and audio accessed from the bus 10 over a most recent predetermined time period to the corresponding event. A conventional PC 36 may be coupled to the BIM 34 or communicate therewith via the FireWire bus and used to retrieve and display a synchronized image of video and communications data from the storage device 32 via the BIM 34. The PC 36 which may be of the type manufactured by Dell under the model denoted as Inspiron 7000, for example, may also be used to configure the overall system via the BIM 34 and bus 10. The BIM 34 may be of the type manufactured by Mindready bearing model no. BIM01, for example.

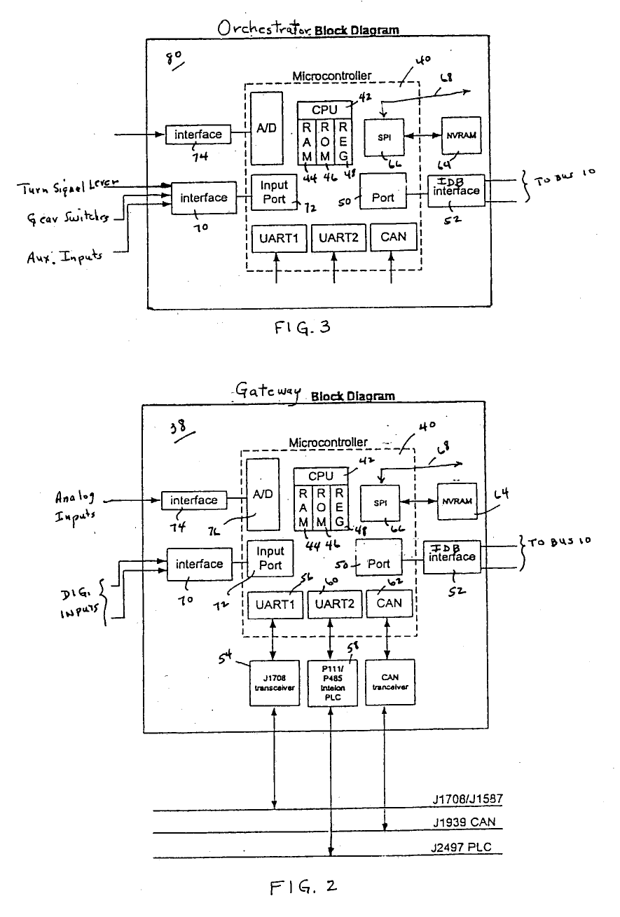

Also included in the system embodiment of FIG. 1 is an electronic control unit (ECU) 38 which operates as a listening device or gateway between the JBUSes of the commercial vehicle, which may include the buses J1939, J1587, J2497, and J1922, for example, and the IDB bus 10. Generally, other resources of the commercial vehicle communicate amongst each other through digital messages of a standardized format or protocol over the JBUSes. In the present embodiment, the gateway ECU 38 is operative under program control to receive and filter the digital messages from the JBUSes (J1939 CAN, J1587/J1708 Diagnostics, and J2497 PLC) and transmit data relevant to the system to the IDB bus 10. In essence, the gateway unit 38 acts as a FireWire bus node. FIG. 2 is a block diagram schematic of an exemplary gateway ECU embodiment suitable for use in the system of FIG. 1.

Referring to FIG. 2, the gateway ECU 38 includes a microcontroller IC 40 which may be of the type manufactured by Motorola under the model no. MMC2107 or of the type manufactured by Infineon under model no. C161, for example. The microcontroller 40 may comprise a central processing unit (CPU) 42, random access memory (RAM) 44, read only memory (ROM) 46, and special function registers (REG) 48. The CPU 42 may communicate with other units of the microcontroller 40 over address, data and control buses (not shown) distributed throughout the microcontroller 40 as is well known to all those skilled in the pertinent art. The microcontroller 40 utilizes a port 50 for communicating with the IDB bus 10 via a IDB interface 52 which may be comprised of conventional bus interface IC modules, like the 1394 link layer controller (TSB 12LV32) and the 1394 physical layer controller (TSB 41LV03, for example. The CPU 42 includes embedded software of the IDB bus protocol suitable for controlling the IDB bus interface 52 via serial port 50 to deposit data onto and retrieve data from bus 10.

Also included in the gateway ECU 38 are devices for communicating with the various JBUSes of the commercial vehicle. For example, a J1708/J1587 transceiver IC 54 which may be of the type manufactured by Linear Technology under model no. RS-485, for example, may be coupled between the J1708/J1587 bus and a universal asynchronous receiver/transmitter (UART1) circuit 56 disposed in the microcontroller IC 40, a J2497 PLC transceiver IC 58 which may be of the type manufactured by Intelon under model no. P485 or P411, for example, may be coupled between the J2497 PLC bus and another UART2 circuit 60 also disposed in the IC 40, and a CAN transceiver, which may be of the type manufactured by Intel under model no. 82C250, for example, may be coupled between the J1939 CAN bus and a CAN receiver/transmitter circuit 62 disposed in the IC 40. Software may be embedded in the microcontroller 40 for exercising the foregoing described interfaces to deposit data on and retrieve data from the various JBUSes.

Accordingly, under program control and/ or as commanded, the gateway ECU 38 may retrieve data from the various JBUSes of the vehicle and deposit such data on the IDB 10 for utilization by other units interfaced to the bus 10 as will become more evident from the following description. In addition, the microcontroller 40 may store program instructions and data in a non-volatile RAM (NVRAM) 64 via a serial peripheral interface (SPI) circuit 66 disposed in the IC 40. The SPI circuit 66 may be also utilized to communicate with other devices or another microcontroller via a serial communication bus 68 under the programmed control of the microcontroller 40. The gateway ECU 38 is also capable of accepting digital inputs which may be status indications of other resources of the vehicle, for example, through an interface circuit 70 and input port 72 disposed in the IC 40. Analog inputs from various sensors disposed on the vehicle may also be accepted by the ECU 38 through an interface circuit 74 which may be a conventional analog signal multiplexer, for example, and an analog-to-digital converter (A/D) circuit 76 also disposed on the IC 40. The reading in of digital inputs and digitized analog inputs is performed by the microcontroller 40 through embedded software as is well known to all those skilled in the pertinent art.

Returning to FIG. 1, a master bus controller 80 which is referred to as an orchestrator in the present embodiment is coupled to the IDB bus 10 for performing master control functions over the various slave devices coupled to the bus 10 in the present embodiment. A primary function of the orchestrator 80 is to match the video image data from the cameras 12, 14, 16, 18 and 24 with the appropriate display 28 and 30. That is, orchestrator 80 may send a command signal to a selected camera via bus 10 to transmit compressed digital video image data over the bus 10 and send a command to one of the displays 28 or 30 to retrieve the image data from the bus 10 originating from the selected camera. Since the current state of the present system embodiment is bandwidth limited to around 80-100 Mb/s, only 2 dedicated DV channels may be used to display camera images. The Orchestrator 80 may be programmed with a look-up table to match the displays 28 and 30 to the cameras based on certain predetermined criteria as will become better understood from the more detailed description found herein below.

In the present system embodiment, information regarding the Vehicle Direction (forward, reverse, stopped) which may be obtained through hardwired connections to status switches coupled to the gear shift lever, for example, and the Turn Signal status (right, left, off) which may be obtained through hardwired switches coupled to the turn signal lever, for example, are coupled to the orchestrator 80 for use thereby in conjunction with the look-up table to control camera-to-display video data flow over the IDB bus 10.

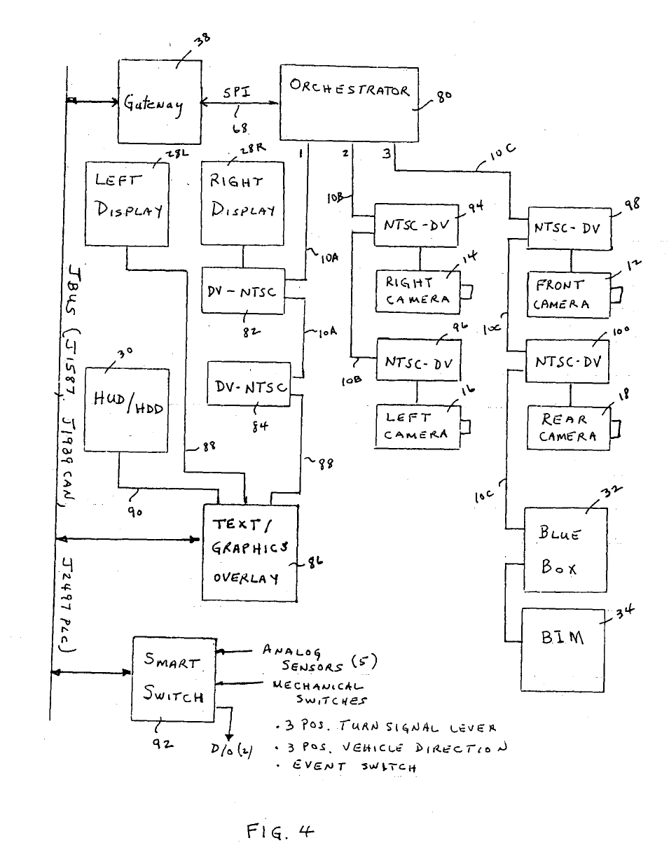

FIG. 3 is a block diagram schematic of an exemplary embodiment of the orchestrator suitable for use in the system of FIG. 1. In the present embodiment, the orchestrator 80 may be a standalone PC board of the type manufactured by Mindready Solutions Inc. under the model no. SD-IO-400, for example. Referring to FIG. 3, a microcontroller which may be the same or similar to the microcontroller IC 40 described in connection with the gateway ECU 38 of FIG. 3, for example, is the primary control circuit for the orchestrator 80. Like reference numerals will be used for like components already described for the embodiment of FIG. 3. In this embodiment, the turn signal lever switch data, gear shift switch data and auxiliary digital data may be coupled to the interface 70 which passes selected digital data to the microcontroller 40 via input port 72 under program control. For example, under program control, the microcontroller 40 may read in the status of the various switches coupled thereto periodically and store the most recent switch status data in memory for use in conjunction with the look-up table to control camera-to-display image data flow over the IDB bus 10. The orchestrator 80 may communicate with the IDB bus 10 using the serial port 50 of the microcontroller 40 and the IDB interface circuits 52 which have already been described herein above. Reference is made to the Mindready User Manual entitled “SD-IO-400, IEEE-1394 Standalone Board”, Edition 2, Revision 3 published in 2001 by Mindready Solutions Inc. which is incorporated by reference herein for a more detailed description of the architecture and operation of an exemplary orchestrator or bus master embodiment.

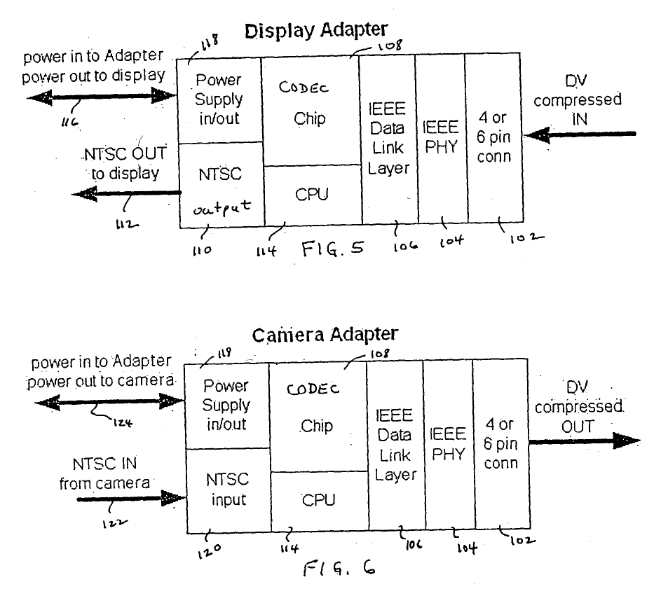

An alternate embodiment of the on-board integrated video/data system for commercial vehicles is exemplified by the block diagram schematic of FIG. 4. Like reference numerals will be used for describing like components already described in connection with the embodiment of FIG. 1. Referring to FIG. 4, the orchestrator 80 is operative under program control to control the communication over the IDB bus 10 which is divided into buses 10A, 10B and 10C, for example, which are daisy-chained to various of the system components. For example, a right side flat panel display monitor 28R, which is not FireWire bus compatible, is coupled to the bus 10A through a DV-NTSC converter 82 and a left side flat panel display monitor 28L, which is also not FireWire bus compatible, is coupled to the bus 10A through another DV-NTSC converter 84. Note that in the present embodiment, the bus 10A is daisy-chained between converters 82 and 84.

A text/graphics overlay unit 86 is coupled in series with an NTSC signal line 88 between the converter 84 and display 28L. The unit 86 may also drive the HUD/HDD display 30 from the NTSC video signal 88 over signal line 90. As will become better understood from the more detailed description below, the unit 86 is operative to superimpose text data and graphic alarm indications on top of the NTSC video signal which drives display 28L and/or display 30. Unit 86 is also coupled to the JBUSes of the vehicle and is operative to retrieve data messages from the JBUSes for display on the displays 28L and/or 30.

A smart switch device 92 is also coupled to the JBUSes of the vehicle for providing status messages over the JBUSes. In the present embodiment, the smart switch device 92 may read in analog signals from up to five (5) sensors disposed on-board the vehicle, and the status of mechanical switches which may include the 3-position turn signal lever switch, the 3-position vehicle direction switch from the gear lever and certain switches indicative of real time events. The smart switch 92 is operative to convert the status of the aforementioned switches to message format for distribution over the JBUSes to other units of the system, like the overlay unit 86 and the gateway 38, for example. The smart switch 92 is also operative to determine the status of the analog sensor measurements by comparison to pre-stored thresholds for conversion and distribution over the JBUSes. These and other functions of the smart switch 92 will become better understood from the more detailed description thereof herein below.

The right side and left side mounted cameras 14 and 16, which are not FireWire compatible, may be respectively coupled to the bus 10B through corresponding NTSC-DV converter circuits 94 and 96. Note that in the present embodiment, the bus 10B is daisy-chained between the converters 94 and 96. Similarly, the front and rear mounted cameras 12 and 18, which are not FireWire compatible, may be respectively coupled to the bus 10C through corresponding NTSC-DV converter circuits 98 and 100. Note that in the present embodiment, the bus 10B is daisy-chained between the converters 98 and 100. The mass storage unit or Blue box 32 is also coupled to the bus 10C for storage of data, and video and audio scene information as managed by the management unit 34.

Also in the present embodiment, the gateway ECU 38 is coupled to the JBUSes and operates much in the same manner as described in connection with the embodiment of FIG. 2 except that the gateway ECU of the present embodiment communicates with the orchestrator 80 on a microcontroller-to-microcontroller basis utilizing the SPI bus 68. Accordingly, the gateway ECU 38 may retrieve from the JBUSes the status messages transmitted by the smart switch 92 and relay the turn signal and gear shift switch status to the orchestrator 80 for use therein over the SPI bus 68.

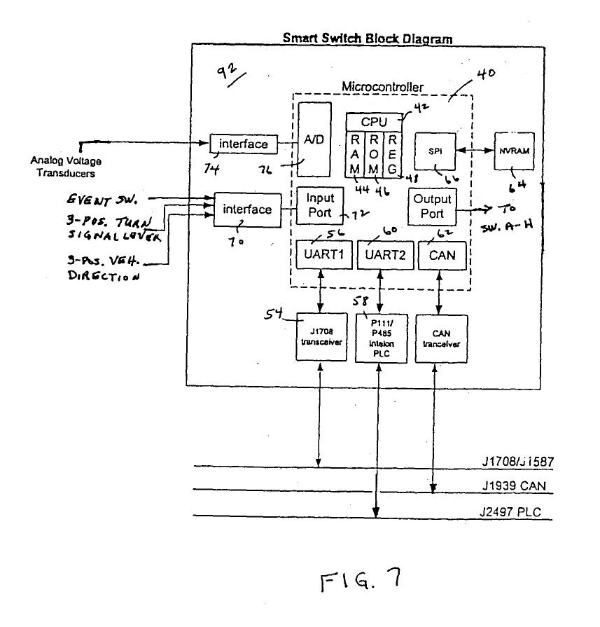

FIG. 5 is a block diagram schematic of an exemplary embodiment of a DV-NTSC converter circuit suitable for use as the units 82 and 84 in the system embodiment of FIG. 4. Referring to FIG. 5, the function of the DV-NTSC converter is to convert compressed digital video (DV) image data retrieved from the IDB bus 10 to raster scan analog image data for display on an analog NTSC monitor. The display converter or adapter is coupled to the IDB bus 10 through a standard 4 or 6 pin connector which couples the bus 10 to an IDB interface comprising the circuits of a 1394 physical layer controller (TSB 41LV03) and a 1394 data link layer controller (TSB 12LV32) 106, for example. DV image data extracted from the bus 10 by the bus interface is passed along to a DV-SD CODEC DV25 integrated circuit 108 which may be of the type manufactured by Divio Inc. under the model no. NW701, for example. The CODEC circuit 108 decodes the DV image data extracted from the IDB bus 10 by the circuits 104 and 106 and provides NTSC formatted video data to the respective monitor through a conventional NTSC output 110 and signals lines 112. Coordinated control and timing for the circuits 104, 106 and 108 is provided by a programmed CPU IC 114. Power is provided to the DV-NTSC converter from a power source over lines 116 through a power supply in/out coupling 118 which includes electrical transient and load dump protection. In the present embodiment, the input power is permitted to pass through the coupling 118 and supplied to the respective monitor over signal lines 116. Reference is made to the “DV25 CODEC Technical Manual”, Rev. 1.06, published October 1999 by Divio Inc. which is incorporated by reference herein for a more detailed description of the structure and operation of the CODEC circuit. In an alternate embodiment, an “off-the-shelf” Dazzle box manufactured by Dazzle Company under the model denoted as “Hollywood DV Bridge”, for example, may be used as the DV-NTSC converter circuit.

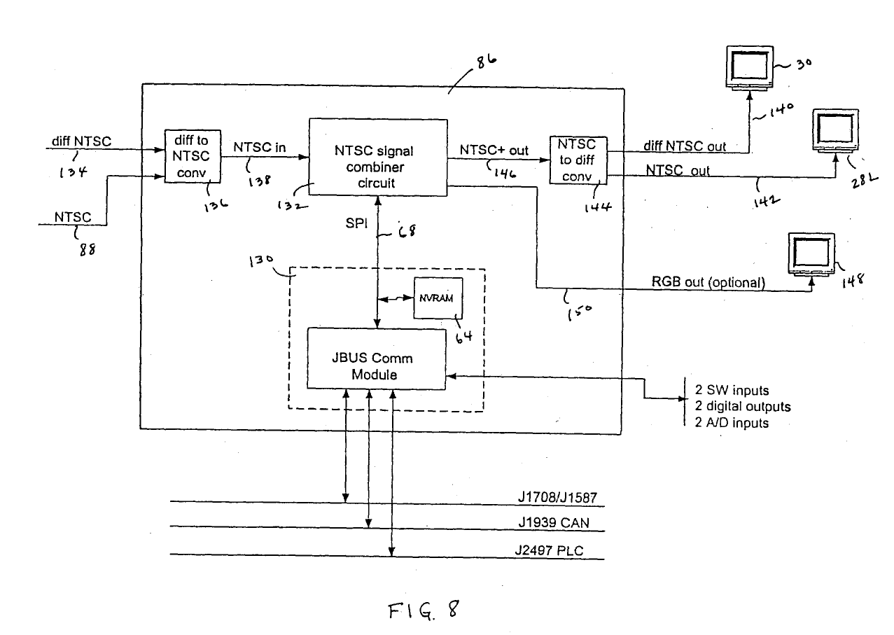

FIG. 6 is a block diagram schematic of an exemplary embodiment of a NTSC-DV converter circuit suitable for use as the units 94, 96, 98 and 100 in the system embodiment of FIG. 4. Referring to FIG. 6, the camera converter or adapter comprises the same or similar circuits as described in connection with the DV-NTSC converter here above except that the function of the NTSC-DV converter is to convert NTSC raster scan analog image data output from an analog NTSC camera into compressed digital video (DV) image data for transmission over the IDB bus 10. In the present embodiment, NTSC formatted video data is received by an NTSC input coupling 120 which is coupled to the respective camera over signal lines 122. The CODEC circuit 108 encodes the NTSC formatted video data into DV image data which is supplied to the IDB bus 10 by the circuits 104 and 106 which are coupled to the IDB bus 10 through the standard 4 or 6 pin connector. Coordinated control and timing for the circuits 104, 106 and 108 is provided by the programmed CPU IC 114. Power is provided to the NTSC-DV converter from a power source over lines 124 through a power supply in/out coupling 118 which includes electrical transient and load dump protection. In the present embodiment, the input power is permitted to pass through the coupling 118 and supplied to the respective camera over signal lines 124. In an alternate embodiment, an “off-the-shelf” Dazzle box manufactured by Dazzle Company under the model denoted as “Hollywood DV Bridge”, for example, may be used as the NTSC-DV converter circuit.

As will become better understood from the more detailed description below, the orchestrator 80 issues commands over the IDB bus 10 to select which camera 12, 14, 16, or 18 is to supply its image data to which monitor 28L or 28R, for example. The NTSC-DV converters 94, 96, 98 and 100 associated with the cameras 14, 16, 12 and 18, respectively, are operative to receive the commands issued by the orchestrator 80 via the interface circuits 104 and 106 thereof, and to decode them in the programmed CPU 114 which governs the operations of the CODEC circuit 108 and interface circuits 104 and 106 to supply or not supply DV image data over the bus 10 in response to such commands. Likewise, the DV-NTSC converters 82 and 84 associated with the monitors 28R and 28L, respectively, are operative to receive the commands issued by the orchestrator 80 via the interface circuits 104 and 106 thereof, and to decode them in the programmed CPU 114 which governs the operations of the CODEC circuit 108 and interface circuits 104 and 106 to process or not to process DV image data received over bus 10 from the selected source camera in response to such commands. For example, if the orchestrator 80 decided to display the image from camera 14 on monitor 28R, then it would issue a command to the NTSC-DV 94 to commence supplying DV image data along with its camera source code over the bus 10. The orchestrator 80 would also issue a command to the DV-NTSC 82 to receive DV image data supplied from the camera 14 over the bus 10 and process such data for display on the monitor 28R. Thus, the camera-to-monitor connection via the IDB bus 10 and associated converters will continue until subsequent commands are issued by the orchestrator 80.

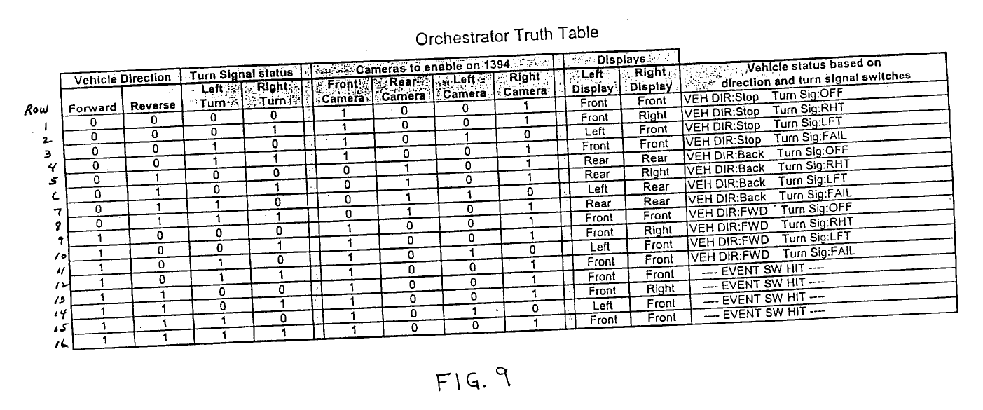

FIG. 7 is a block diagram schematic of an exemplary embodiment of a smart switch 92 suitable for use in the integrated system of FIG. 4. In this embodiment, the circuit components are much the same or similar to those described in connection with the gateway ECU 38 illustrated in FIG. 2. Accordingly, for the smart switch embodiment, like reference numerals will be used for like circuit components already described for the gateway ECU 38. Referring to FIG. 7, the 3-pos. turn signal lever switch, the 3-pos. vehicle direction or gear shift switch and certain event switches are coupled to microcontroller 40 via the digital interface 70 and input port 72. Accordingly, under program control, the microcontroller 40 may read in the status of the aforementioned switches periodically or otherwise and store the most recent status in appropriate registers of memory. In addition, analog measurements from selected sensors on-board the vehicle may be coupled to the microcontroller 40 via the multiplexer interface 74 and A/D 76. The microcontroller 40 under program control may also read in these digitized analog measurement signals and store the values thereof in appropriate registers of memory.

The smart switch 92 may include predetermined thresholds associated with the various sensor measurement values stored in a memory thereof, like the NVRAM 64, for example. From time to time or periodically, the microcontroller 40 may compare the stored measurement values with the corresponding stored thresholds to determine whether or not an indication should be issued, like low battery voltage or high coolant temperature, for example. When it is determined that an indication should be issued for a sensor measurement, the microcontroller 40 may convert the indication into a message format for transmission over the JBUSes of the vehicle. The microcontroller 40 is also operative under program control to convert the most recent stored status of the turn signal lever switch, the gear shift switch and the one or more event switches into a message format for transmission over the JBUSes.

The smart switch 92 may be coupled to the JBUSes of the vehicle in a similar manner as described for the gateway ECU 38. For example, the microcontroller 40 is coupled through UART1 56 and transceiver 54 to the J1587 bus, through UART2 60 and transceiver 58 to the J2497 bus, and through CAN 62 and CAN transceiver to the J1939 bus. Accordingly, the microcontroller 40 may transmit the status messages over one or more of the JBUSes utilizing the appropriate interface circuitry. In the system embodiment of FIG. 4, the messages may be read from the JBUSes by the gateway ECU 38 as described above, reconverted to their respective digital status signals and conveyed to the orchestrator 80 over the SPI bus 68 for further processing therein as will become more evident from the following description.

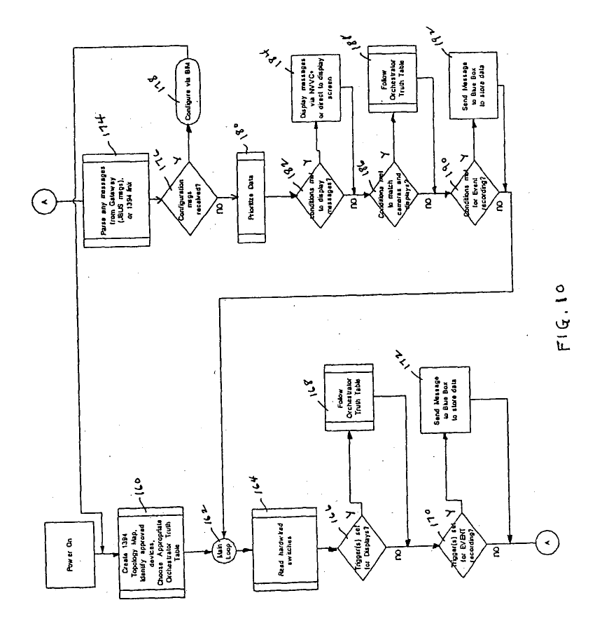

FIG. 8 is a block diagram schematic of an exemplary embodiment of the text/graphics overlay circuit 86 suitable for use in the integrated system of FIG. 4. Referring to FIG. 8, the circuit 86 comprises a JBUS communication module 130 which may include the same or similar circuitry as described for the gateway ECU 38 and smart switch 92 herein above, for example. Also, the module 130 may be coupled to the JBUSes in the same manner as described for the gateway ECU 38 and smart switch 92 for transmitting messages over and receiving messages from the JBUSes. In addition, the module 130 may have predetermined text and graphics stored in a memory, such as the NVRAM 64, for example, which may be provided to a combiner circuit 132 over the SPI bus 68, for example, in response to an appropriate message or messages received from the JBUSes. More specifically, the microcontroller 40 may be programmed to convert a message received from the JBUSes and determine what action should be taken in response thereto. For example, if a battery low status message is received, the microcontroller 40 may respond by accessing the stored text “battery low” from the NVRAM 64 and providing it to the combiner circuit 132 over the SPI bus 68 along with the position on the screen image where the text is to be displayed.

The combiner circuit 132 which may be an off-the-shelf circuit of the type manufactured by ST Micro Company, under the model no. STV5730A, for example, receives the text and/or graphic information and corresponding screen position and superimposes the text and/or graphics (e.g. icons) onto the NTSC formatted video image at the designated position. The resulting video plus text/graphic image referred to as NTSC+ is then output to the appropriate display monitor. In the present embodiment, the combiner circuit 132 is disposed in series with the NTSC video signal. It is understood that different cameras may generate either a single-ended or differential NTSC video signal. Generally, an NV camera generates a differential NTSC video signal 134 and a video camera and the DV-NTSC converter circuit generates a single-ended signal 88. The circuit 86 may accommodate either signal through use of a differential to NTSC converter circuit 136 which passes the single ended NTSC signal and converts the differential NTSC signal to a single ended signal, for example. The resulting single-ended signal is provided to the combiner circuit 132 over signal line 138.

Similarly, it is understood that different monitors are driven by either a single-ended or differential NTSC video signal. Generally, a HUD/HDD monitor, like the monitor 30, for example, is driven by a differential NTSC video signal 140 and a convention flat panel display monitor, like the monitor 28L or 28R, for example, is driven by a single-ended NTSC video signal 142. The circuit 86 also accommodates either type monitor through utilization of a NTSC to differential converter circuit 144 which passes the single-ended NTSC+ video/text signal output from the combiner circuit over signal line 146 to the monitor 28L over line 142 and converts the NTSC+ video/text signal to a differential video/text signal for driving monitor 30 over lines 140. The combiner circuit 132 may also drive a conventional computer monitor 148 with the NTSC+ signal using red, green and blue (RGB) drive signals over signal lines 150.

The communication module 130 may also accommodate a plurality of switch inputs via interface circuit 72 and input port 72 and a plurality of analog inputs via interface 74 and A/D 76 (see FIG. 7). The microcontroller 40 thereof may read in the inputs and determine the status thereof, then create messages representative of each input status for transmission over the JBUSes. The microcontroller 40 of circuit 86 is also operative to output a plurality of digital outputs representing either sensor status or event status, for example.

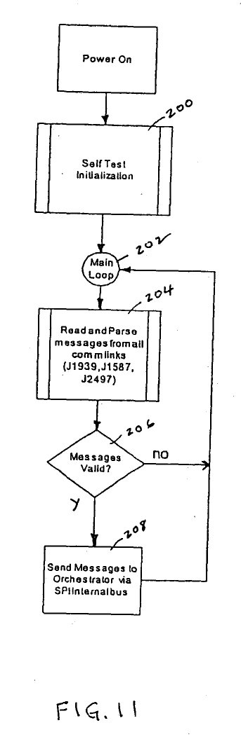

As indicated herein above in connection with the embodiments of FIGS. 1 and 4, the orchestrator 80 operates as a bus master unit to coordinate the flow of information over the IDB bus 10, especially between cameras and monitors. The orchestrator 80 may be programmed with a look-up or truth table for determining the camera to monitor flow of information governed by the operational status of the vehicle, like forward and reverse driving direction and/or right or left turn conditions, for example. A suitable truth table for programming into the orchestrator for this purpose is found in FIG. 9. Referring to the truth table of FIG. 9, the first four columns represent the status determined from the turn signal lever and gear selector switch which may either be connected directly to the orchestrator 80 as described in connection with the system embodiment of FIG. 1 or determined by the smart switch and conveyed to the orchestrator 80 via the JBUSes and gateway ECU 38 over the SPI bus 68 as described in connection with the system embodiment of FIG. 4.

Dependent on the status of the first four columns going from left to right, the orchestrator 80 will transmit commands directly to FireWire compatible cameras or to the NTSC-DV converters of the non-compatible cameras over the IDB bus 10 based on the next four columns of the truth table. For example, if the vehicle is moving in reverse and turning left as shown in the state of row 7 of the table, the orchestrator 80 will send commands to the rear mounted camera 18 and the left mounted camera 16, either directly or through their corresponding NTSC-DV converters, to supply their respective DV image data over the bus 10. During this state, the other cameras 12 and 14 will not supply DV image data over the bus 10. Also during the state of row 7, the orchestrator 80 will send commands to the left side and right side monitors 28L and 28R, respectively, either directly or through the corresponding DV-NTSC converters, to receive DV image data from the bus 10 corresponding to the left side mounted camera 16 and rear mounted camera 18, respectively. Accordingly, for the state of row 7, the image from the left side mounted camera 16 will be displayed on the left side monitor 28L and the image from the rear mounted camera 18 will be displayed on the right side monitor 28R. In this manner, the orchestrator 80 will govern the camera to monitor image flow over the bus 10 in accordance with the rows or states 1-12 of the table of FIG. 9. Note that in the present embodiment the states 13-16 of the truth table are undefined, i. e. the vehicle can not physically move both in a forward and reverse direction. In the present embodiment, states 13-16 accommodate event triggers to initiate an immediate operation, such as storing images to a mass storage device 32 for later scene reconstruction, for example. Camera image to display monitor combinations of states 13-16 will be treated in the same manner as states 9-12, respectively.

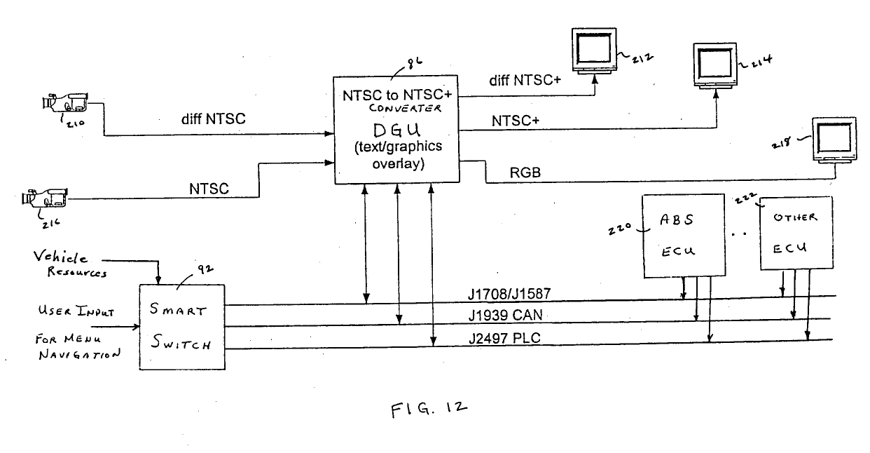

FIG. 10 is an exemplary program flow chart suitable for use in programming the microcontroller of the orchestrator 80 for either the system embodiment of FIG. 1 or system embodiment of FIG. 4. The orchestrator 80 may execute the instructions of the program of FIG. 10 to carry out its bus master tasks in operating the respective system embodiment. Referring to FIG. 10, as power is turned on, the program goes through certain initialization procedures in block 160. For example, it may create a 1394 topology map of devices connected to the bus 10 and identify approved devices for communicating over the bus 10. Then, it may choose an appropriate truth table, like the one described in connection with FIG. 9, for example, to govern the camera to monitor image flow over the bus 10. Thereafter, the main loop of the program begins at 162 wherein the first task starts at block 164. In block 164, the status of the switches are read into designated registers of a memory of the orchestrator 80. This may be accomplished in the system embodiment of FIG. 1 through monitoring the designated digital inputs of the microcontroller 40 thereof. In the system embodiment of FIG. 4, the orchestrator 80 may read in the status of the switches through the SPI bus 68 from the gateway ECU 38 which receives the status messages from the JBUSes where they were deposited by the smart switch 92 as described herein above.

Next, in decision block 166, the program determines if one or more trigger conditions are set for the displays. If so, in block 168 the program establishes the appropriate camera to monitor image flow from the truth table based on the status of the turn signal and gear switches read in by block 164, for example. If no trigger is set or after the truth table is followed in block 168, program execution continues at decision block 170 wherein it is determined if one or more triggers are set for event recording. This may established for the system embodiment of FIG. 1 by reading in one or more event switches through the auxiliary inputs directly connected to the microcontroller of the orchestrator 80 (block 164). For the system embodiment of FIG. 4, status messages of the event switches are supplied over the JBUSes via smart switch 92 and received by the gateway ECU 38 which conveys them to the orchestrator 80 via the SPI bus 68 where they are stored in designated memory. Thus, the status of the event switches may be determined by block 170 by accessing the memory designated therefor.

If a recording trigger is set, then in block 172, a message (command) is set to the management unit 34 to start recording the DV image data (both video and audio) from the bus 10 into a designated channel of the mass storage device 32 for a predetermined period of time. Concurrently, the orchestrator 80 may establish from the set trigger which of the cameras to supply DV image data over the bus 10 for mass storage. In synchronization with the DV image data, the mass storage device may store in separate channels selected other data streaming over the bus 10 which may represent status and conditions of the vehicle during the predetermined time period. Accordingly, the mass storage device 32 will have stored therein a complete depiction of video, audio and data for a predetermined time period immediately following an event trigger for accident reconstruction and the like.

After executing block 170 or 172, program execution will continue at block 174 wherein the program parses any JBUS messages received from the gateway ECU 38 either over the IDB bus 10 for the system of FIG. 1 or over the SPI bus 68 for the system of FIG. 4 or any IDB bus messages. Next in block 176, it is determined if any received messages are configuration type messages from the PC 36 via the BIM 34, for example. If so, the system is reconfigured in block 178 according to the received message and program execution continues at block 160 wherein re-initialization takes place. Otherwise, the remaining message data is prioritized for message display and task execution in block 180.

In the next block 182, it is determined if conditions are met for message display. If so, the messages are displayed on the appropriate monitor either directly or through the text/graphics circuit 86 (NVVC+) in block 184. Else, in block 186, it is determined if conditions are met to match cameras to displays. If so, the program follows the chosen truth table in block 188. Else, in block 190, it is determined if conditions are met for event recording. If so, messages are set to the mass storage device 32 via management unit 34 for storage therein in block 192. After execution of either block 190 or 192, program execution is routed back to re-start the main program at block 162. In this manner, the orchestrator 80 provides a bus master operation for the slave devices coupled to the bus 10 for either the system embodiment of FIG. 1 or of FIG. 4.

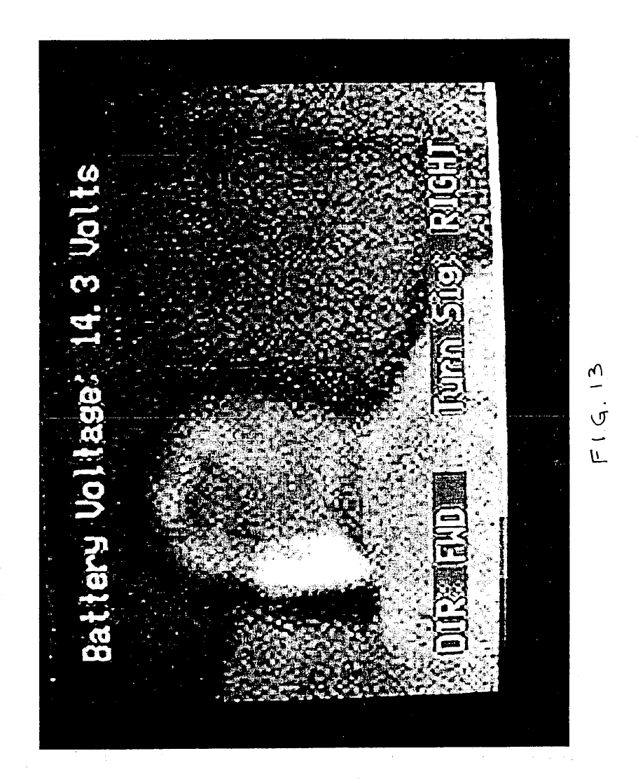

FIG. 11 is an exemplary program flow chart suitable for use in programming the microcontroller of the gateway ECU 38 for either the system embodiment of FIG. 1 or system embodiment of FIG. 4. The gateway ECU 38 may execute the instructions of the program of FIG. 11 to carry out its tasks of receiving messages from the JBUSes and communicating them to the orchestrator unit 80 for the respective system embodiment. Referring to FIG. 11, as power is turned on, the program goes through a self-test initialization sequence in block 200 to ensure that all of the components thereof (see FIG. 2) are operating properly. Thereafter, the program enters the main loop at 202. In the block 204, the program reads in and parses messages from all of the JBUS links. If the messages are determined to be invalid in block 206, program execution is interrupted and returned to the main loop at 202. Otherwise, in block 208, the messages are either converted to a format for transmission over the IDB bus 10 to the orchestrator 80 and transmitted thereover or converted to a format for transmission over the SPI bus 68 to the orchestrator 80 and transmitted thereover. In either case, block 208 transmits the messages to the orchestrator unit 80 for appropriate processing therein as described herein above and then returns program execution to the main loop at 202.

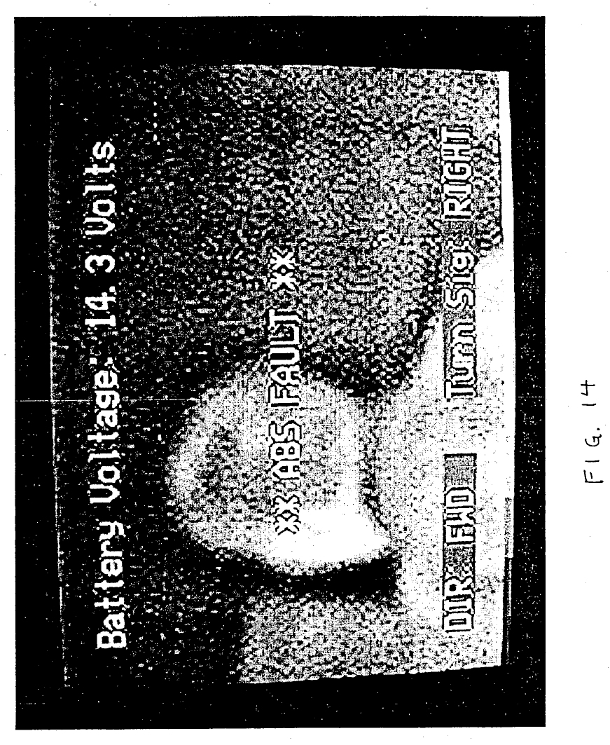

Some commercial vehicles are equipped with a night vision (NV) system, like the Bendix XVision™ system, for example, which is a safety device used to improve the visibility of the vehicle driver during night time operation. Generally, a night vision system as shown in FIG. 12 includes an infrared (IR) camera 210 and a compatible NTSC HUD or HDD 212, or a LCD flat-panel monitor 214, for example. In conventional NV systems, the display is dedicated to night vision viewing and is generally limited to night time use. Since use of the NV system is dedicated to the IR camera 210, other displays and/or indicators are needed in the vehicle cabin for displaying information from other resources to the driver. This is a concern to the commercial vehicle manufacturer since real-estate is at a premium in the cabin. To mitigate the real-estate concern, it would be advantageous if display information from other resources could be integrated into the NV display 212 and/or 214 and/or 218, thereby eliminating the need for the other displays and indicators.

In accordance with another aspect of the present invention, an exemplary embodiment of such a standalone system is depicted in the block diagram schematic of FIG. 12. In this embodiment, the smart switch 92 and the text/graphics overlay circuit 86, also referred to herein as the display generation unit (DGU), may be used in combination with various cameras and monitors as a standalone resource without an IDB bus 10 for communicating information to the driver of the vehicle via one or more display monitors 212 and/or 214. In the embodiment depicted in FIG. 12, only the existing JBUS links are used for communicating messages and data between the DGU 86 and other units which may be coupled to the JBUSes, such as one or more smart switches 92 and diagnostic ECUs, for example. This aspect of the present invention will allow text and/or graphics to be superimposed onto the video image of one or more of the cameras of a standalone vision product thereby enhancing the value of the standalone vision product and enabling integration and prioritization of information from multiple resources and subsystems of the vehicle onto a single display, thereby eliminating redundant displays and reducing driver information overload. This embodiment may also operate as a Diagnostic System Display for more heavy duty applications as will become more evident from the following description.

Referring to FIG. 12, the DGU 86 includes the same or similar circuitry as described in connection with the embodiment of FIG. 8. Accordingly, reference will be made to the circuits of FIG. 8 during the following description of the embodiment of FIG. 12. The DGU 86 may receive both differential NTSC image signals from the IR camera 210 and single-ended NTSC image signals from a video camera 216 that may also be disposed on the vehicle. It is understood that more than one camera of each IR and video may be embodied in the standalone system of FIG. 12 without deviating from the broad principles of this aspect of the present invention. As described herein above, the DGU 86 will manipulate the incoming NTSC signal from either an IR camera or a video camera such that additional desired information is displayed on the screen of the HUD 212 and/or monitor 214 simultaneous with the video or infrared image (NTSC+). Appropriate text or graphic information for display from other resources on the vehicle is chosen for superimposed display based on commands and messages obtained via the vehicle's communication JBUSes, or other inputs as depicted in FIG. 12. The DGU 86 may be programmed to display data in the form of menus for driver menu navigation, if desired, and to prioritize the data displayed in order to reduce driver distraction. The DGU 86 of the present embodiment is also capable of driving a RGB type display 218.

More specifically, one or more smart switches 92 are coupled to the vehicle's JBUSes to communicate user inputs from a joystick, keypad and/or keyboard, for example, for parameter entry, and driver manipulated menu navigation through the various displays. Data from vehicle resources not linked through the JBUSes may also be input to the JBUSes through the smart switch 92. As described herein above, each smart switch 92 is capable of converting the data to commands and messages which are transmitted over the JBUSes using the appropriate protocol. In addition, an antilock braking system (ABS) ECU 220 and other ECUs 222 may be coupled to the JBUSes for providing malfunction and other data related to the respective resource. The microcontroller unit 130 may receive the commands and messages from the JBUSes and react accordingly. In some cases, data received from the JBUSes may be stored in memory for immediate or later display. In the present embodiment, the DGU 86 may have certain screen menu depictions, text, and graphics preprogrammed into a memory thereof, like the NVRAM 64, for example, which may be accessed from menu based on the commands received over the JBUSes.

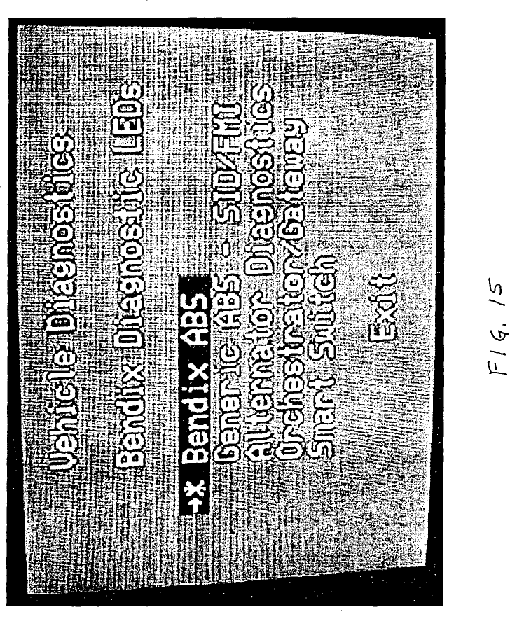

FIGS. 13 through 18 are screen display illustrations provided to exemplify operation of the standalone embodiment of FIG. 12, like overlaying text on the video image, prioritization of diagnostic messages and menu navigation by the user. From the screen image of FIG. 13, it is shown that text may generally be overlaid over a video image by the DGU 86 in order to provide relevant information to the driver, such as on-vehicle battery voltage, the direction of the vehicle and the turn signal status, for example. Other information may likewise be read by the smart switch(es) 92 and/or generated by an ECU 220 or 222 and transmitted to the DGU 86 over the JBUSes for display.

When a fault occurs in the ABS system, it may be detected by the ECU 220, for example, and transmitted to the DGU 86 over the JBUSes for display to the driver. The DGU 86 may respond to the received ABS fault message, by displaying the appropriate pre-stored text message on the screen superimposed over the video image as shown in the screen image of FIG. 14. Thus, the driver may be alerted of the fault condition by the “ABS Fault” text message shown on the screen. A fault text message such as shown in FIG. 14 may be highlighted or blinked to distinguish it from other text messages to gain the attention of the driver. The driver may respond to the fault message to gain additional information about the fault, if desired, by inputting a command through the user interface device via smart switch 92 and JBUSes to instruct the DGU 86 to display an appropriate menu, like the exemplary vehicle diagnostics menu shown in the screen image display FIG. 15.

Also, the driver or user may navigate the displayed menu to select the resource of the fault using the user interface via the smart switch 92 and JBUSes. In the present example as shown in FIG. 15, the driver may select through the user interface the ABS system resource generating the fault condition which may be the Bendix ABS, for example. The DGU 86 responds to the selection message(s) by interrogating the appropriate ECU via the JBUSes to identify the faulted condition which may be stored in a fault memory of the ECU. In the present example, the ECU 220 will respond to the interrogation via the JBUSes to indicate the fault to the DGU 86 which, in turn, is operative to access the appropriate text and/or graphic message from the memory and display it on the monitor. For example, if the fault memory in the ABS ECU 220 indicates a “Right Front Sensor Open” condition has occurred, the DGU 86 may display the text message such as shown in the screen image of FIG. 16, for example, thus directing any subsequent troubleshooting activity to the right spot on the vehicle.

In the alternative, the DGU 86 may have embedded in memory locations thereof the text and graphics to display a screen image of ECU fault indicating LEDs on a monitor inside the cab. This is significant because if the driver is alerted to a fault condition today, without additional assist tools, he or she would have to stop and exit the cab, locate the fault ECU disposed on the outside of the cab and orient the eyes to physically view a set of LEDs disposed at the ECU to determine the fault condition. The LEDs are usually not located at a position on the vehicle for convenient viewing by the driver. With the present embodiment, the status of these LEDs may be displayed to the driver on the common display monitor 212 or 214 upon command using the user interface as described here above. An exemplary screen image of such diagnostic LEDs is shown in FIG. 17. Thus, the user can access the display of LEDs by menu selection from inside the cab for diagnosing the fault condition. It is understood that while displaying a screen image of the ECU LEDs is helpful to the driver by providing an indication that he or she is accustomed to viewing for fault diagnostics, such a display screen will typically provide less information than the fault memory text method discussed above.

From the menu screen image of FIG. 15, it is observed that other ECUs and sub-systems (e.g. Alternator Diagnostics, engine, etc) can be queried for their status through the user interface, smart switch and JBUSes, as well as provide an alert directly to the driver over the JBUSes. If another ECU is chosen for diagnosis by the driver from the menus screen of FIG. 15, for example, the DGU 86 may respond by interrogating the fault memory of the chosen ECU which may be an alternator ECU, for example. The alternator ECU may respond to the DGU 86 with the fault information over the JBUSes. In turn, the DGU 86 will display pre-stored text such as that shown in the screen image of FIG. 18. Note that in FIG. 18, the “Low Battery” text line in the menu is highlighted to indicate a fault condition to the driver. In the present embodiment, the driver may exit any display image by navigating down to, the exit text at the bottom of the screen and selecting it using the user interface. The DGU 86 may be programmed to revert back to the video/text image of FIG. 13 once the fault has been corrected or upon exiting a screen.

In summary, the standalone system embodiment of FIG. 12, permits the driver to view integrated image screens with both image and text overlaid thereover through a common display monitor. The overlaid text may be selected operational data of the vehicle to enhance the driver's operational capabilities and reduce “information overload”. Fault messages are permitted to “pop-up” on the text/video screen as fault data is received over the JBUSes by the DGU 86. The fault text messages may be derived and prioritized from data supplied over the JBUSes from one or more smart switches and resource ECUs of the vehicle. The driver may interact with the screen images using a user interface to select fault text messages and navigate menus for further diagnosis of a selected fault via the smart switch and JBUSes. Accordingly, the standalone system with its integrated and interactive display features is a viable diagnostics tool which combines a multiplicity of heretofore used individual diagnostics tools.

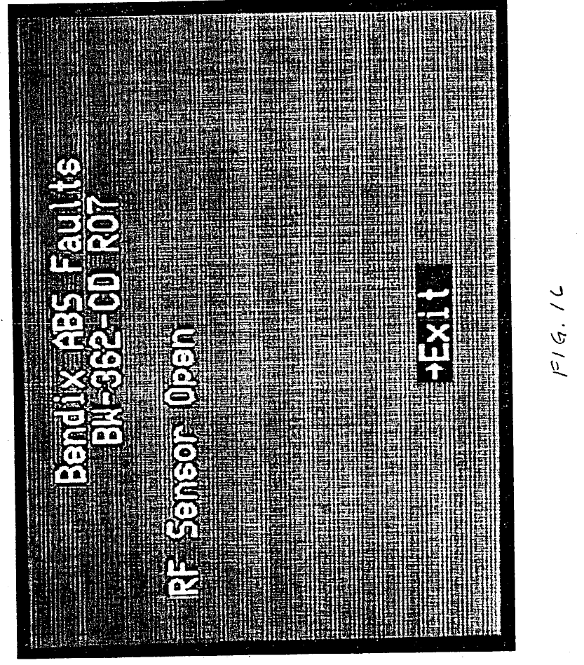

In accordance with yet another aspect of the present invention, an alternate embodiment to the integrated system described in connection with FIG. 4 is shown in schematic diagram of FIG. 19. The embodiment of FIG. 19 provides for the basic automatic camera-to-display selection functions as the embodiment of FIG. 4, but without the IDB 10. Rather, this alternate embodiment includes a switch matrix for selecting by direct connection which camera image of the cameras 12, 14, 16 and 18 is displayed on which display monitor of the monitors 28L and 28R, for example. The present embodiment allows for two camera and two monitor selection as will become better understood from the following description.

Referring to FIG. 19, each camera 14, 16, 12 and 18 is buffered by a buffer amplifier 230, 232, 234 and 236, respectively, to accommodate impedance matching and improve signal transmission efficiency. The switch matrix comprises switches A-H which are individually coupled to and driven by a programmed digital control unit 240. More specifically, one side of switches A and B is commonly coupled to the output of amplifier 230, one side of switches C and D is commonly coupled to the output of amplifier 232, one side of switches E and F is commonly coupled to the output of amplifier 234, and one side of switches G and H is commonly coupled to the output of amplifier 236. The other sides of switches A, C, E, and G are commonly coupled to the monitor 28L through another buffer amplifier 242 and the other sides of switches B, D, F and H are commonly coupled to the monitor 28R through another buffer amplifier 244. The buffer amplifiers 242 and 244 provide similar impedance matching and signal efficiency as buffers 230-236. All of the buffer amplifiers in the present embodiment may be of the type manufactured by National Semiconductor under the model no. LMH 6643, for example. Also included is a power supply 238 comprising load dump protection-consistent with industry standard SAE J1455 and electrical noise and transient suppression.

The smart switch 92 is coupled to the JBUSes and provides data of the vehicle direction, the turn signal status and possibly, the steering angle, for example, to the controller 240 via the JBUSes much the same as described in connection with the embodiment of FIGS. 4 and 7. In addition, the controller 240 comprises much the same circuitry as described for the smart switch shown in FIG. 7, except that the controller 240 includes a digital output port which connects the microcontroller 40 to the switches A-H, individually. Thus, the microcontroller 40 may drive individually each of the switches A-H open or closed dependent on the status of the vehicle operation which it receives from the smart switch 92 via the JBUSes. Accordingly, this aspect of the present invention allows for automatic and intelligent camera-to-display image selection based on information from the communication buses on the vehicle. Criteria for the selected image is based on driver input, vehicle status, and a prioritization of the activity on the JBUS links, for example.

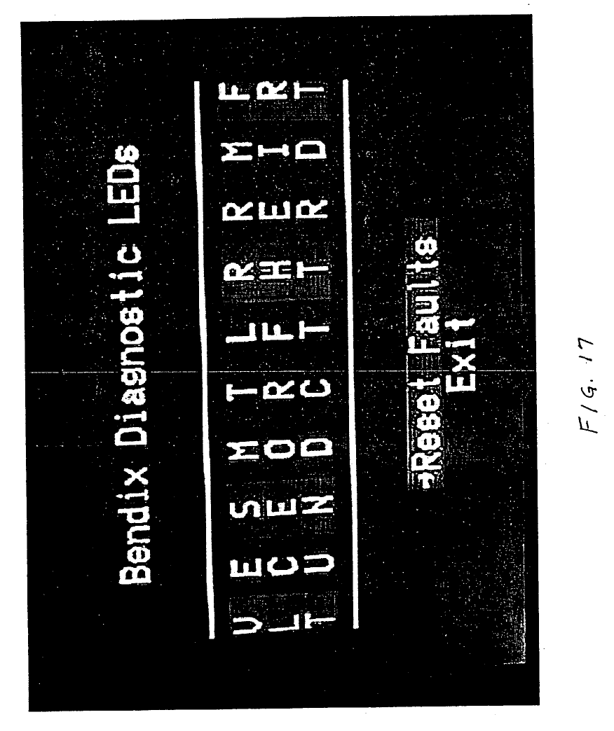

FIG. 20 depicts an exemplary circuit schematic of a switch suitable for use for each of the switches A-H in FIG. 19. One side 246 of the switch is coupled to the other side 248 through dual series connected MOSFET solid state switches 250 and 252. In the present embodiment, the gates of the switches 250 and 252 are biased to a positive supply voltage, like 28V, for example, through a resistor R4 which may be on the order of 4.7K ohms. Thus, the MOSFET switches are biased in a conducting state, i. e. closed. The gates of switches 250 and 252 are coupled to ground potential through the collector-emitter junction of an NPN transistor 254 which is driven to conduction by a logic high enable signal EN_A (bar) through a series connected resister divider network R12 and R5 also coupled to ground potential. In the present embodiment, R12 and R5 may be on the order of 10K ohms and 4.7K ohms, respectively. So when signal EN_A (bar) is logically high, the NPN transistor 254 conducts and the switches 250 and 252 are driven to an open circuited or non-conducting state. When the signal EN_A (bar) is logically low, the NPN transistor 254 becomes nonconducting, and the gates of switches 250 and 252 are pulled to the level of the positive supply voltage which renders switches 250 and 252 closed or conducting.

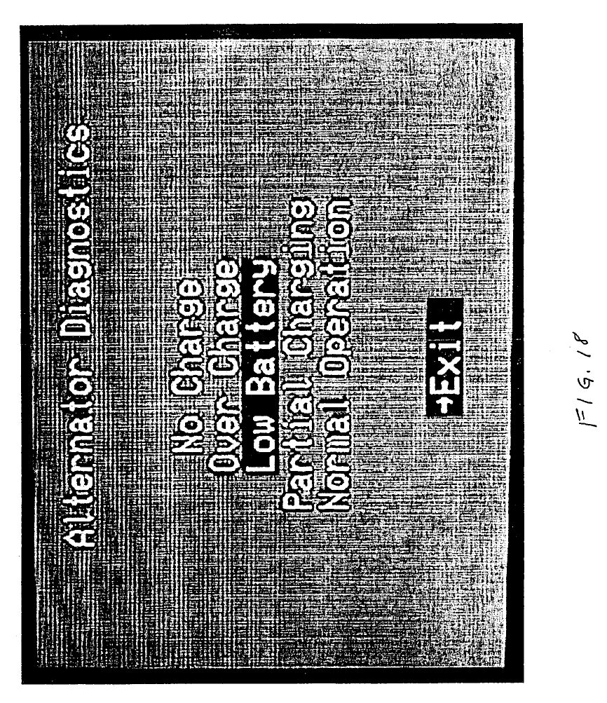

In the present embodiment, the switches A-H may be driven by the programmed controller 240 in accordance with a look-up or truth table which may be pre-programmed into a memory thereof, like the NVRAM, for example. A suitable truth table for this purpose is exemplified in FIG. 21. Referring to the table of FIG. 21, the first two columns going from left to right indicate the status of the vehicle direction, i. e. forward or reverse. A one in a box of these columns is indicative of vehicle movement. Note that the last four rows 13-16 are not allowed because the vehicle can not simultaneously travel in both the forward and reverse directions. The next two columns going from left to right indicate the status of the turn signal lever, i. e. left turn or right turn. A one in a box of these columns is indicative of the direction of vehicle turn. The next columns going from left to right are the switch connections controlled by the controller 240 to achieve the camera to monitor selection shown in the next two columns, left display and right display.

For example, if the vehicle is moving forward and turning right, then this status data is transmitted to the controller 240 over the JBUSes by the smart switch 92. As the controller 240 senses the operational status of the vehicle, it refers to the look-up table, row 10 to determine which switches A-H are to be closed to display the front camera image on the left side display and the right side camera image on the right side display. To achieve these camera to monitor selections, switches B and E are controlled closed by controller 240 in accordance with the look-up table. As shown in FIG. 19, with switch B closed, the NTSC signal from the right side camera 14 is coupled directly through buffer amplifiers 230 and 244 to the right side monitor 28R. Likewise, with switch E closed, the NTSC signal from the front view camera 12 is coupled directly through the buffer amplifiers 234 and 242 to the left side monitor 28L. The signals from the other cameras are prohibited from being displayed by the open states of the remaining switches A, C-D and F-H. In this manner, when an operational status is determined by the controller 240, the proper switches of the switch matrix are controlled closed to effect the pre-programmed camera to monitor selections of the truth table.,

Of course, the pre-programmed selections of the truth table may be altered based on incoming messages from the vehicle JBUS links as determined by the controller 240. For example, by reading the road speed message distributed over the JBUSes, the controller 240 may determine that the driver is attempting to park the vehicle. In this case, the controller 240 may perform a “park assist” function by displaying the left side camera image on the left side display and the right side camera image on the right side display. This display selection assists the driver park the vehicle, or maneuver the vehicle when in tight spots. Such a function may be programmed as a task in the controller 240 and executed as the indicated vehicle conditions arise. Another example of altering the system embodiment configuration may be achieved by adding auxiliary inputs (e.g. VCR, DVD, TV, etc) which may be switched on for dedicated viewing on a selected display and would be excluded from the camera-to-display selection process on demand.

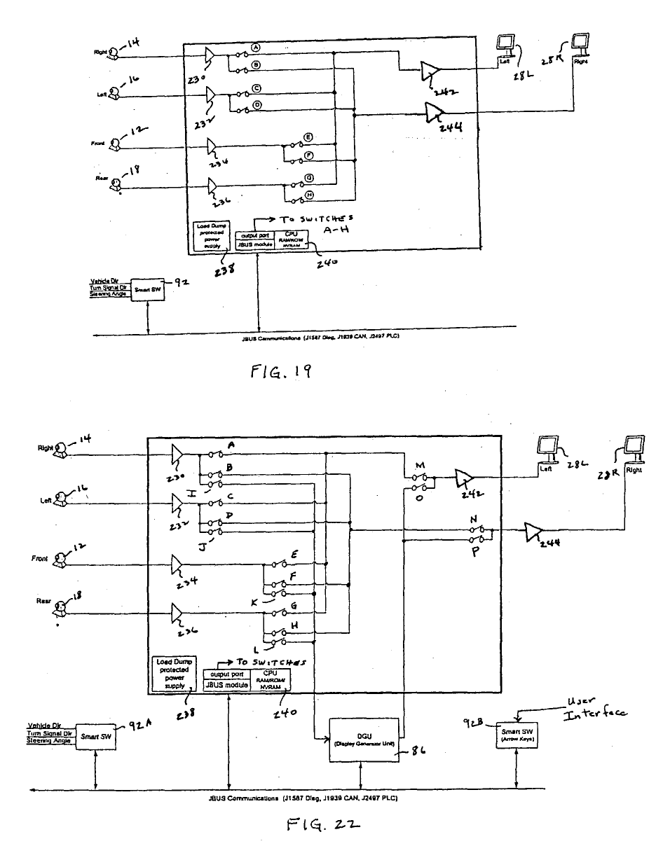

Also, the embodiment of FIG. 19 is capable of working with the NTSC+ Text/Graphics Overlay ECU or DGU 86 so that the driver is alerted of important events on an exception basis through text and/or graphic messages overlaid on the video image of one of the monitors 28L or 28R. This eliminates the need for redundant devices and resources on-board the vehicle, thereby aiding with real-estate management, and reduces driver distraction since it enables the multi-functional use of an on-board vehicle display via the menu driven diagnostics tool mode as described herein above in connection with the embodiment of FIG. 12, for example. An exemplary embodiment for this purpose is illustrated in the block diagram schematic of FIG. 22.

The embodiment of FIG. 22 has the same basic circuit architecture and switch matrix network comprising switches A-H as described for the embodiment of FIG. 19. In the embodiment of FIG. 22, an additional switch is added in parallel to each parallel pair of switches coupled to the output of buffer amplifiers 230, 232, 234, and 236. More specifically, switches I, J, K and L have one side coupled to the output of amplifiers 230, 232, 234, and 236, respectively, and their other sides coupled commonly to the input of the DGU 86. In addition, a switch M is coupled between the node commonly coupling the other sides of switches A, C, E, and G and the input of amplifier 242, and a switch N is coupled between the node commonly coupling the other sides of switches B, D, F, and H and the input of amplifier 244. Still further, switches O and P are added coupled between the output of the DGU 86 and the inputs of the amplifiers 242 and 244, respectively. Also, in this embodiment, a smart switch 92A may be included coupled to the JBUSes to provide the vehicle status signals over the JBUSes for reception by the controller 240 and DGU 86 and another smart switch 92B may be included coupled to the JBUSes to provide signals from a user interface over the JBUSes for controlling parameter entry, text message selection and menu navigation of screen data as described in connection with the embodiment of FIG. 12. Other ECUs, like ECU 222, for example, may be coupled to the JBUSes such as described for the embodiment of FIG. 12 for interacting with and providing fault and diagnostic messages to the DGU 86 for use as a diagnostic tool.

In operation, the switches A-H may be controlled in accordance with the truth table of FIG. 21 much as described for the embodiment of FIG. 19 except when text and/or graphics is (are) to be superimposed over the video NTSC signal (NTSC+) or when being menu driven for diagnostic analysis as will become more evident from the following description. Using the same truth table example of row 10 (see FIG. 21) as described herein above for FIG. 19, switch B is closed to display the front camera image on the left side display and switch E is closed to display the right side camera image on the right side display. Note that switches M and N are additionally controlled closed to display the images directly from the selected cameras. When operational text messages are to be superimposed on the video image of one of the monitors, like monitor 28L, for example, then switches K and O are controlled closed instead of switches E and M, thus, permitting the video NTSC signal from camera 12 to pass through the DGU 86 before being displayed on the monitor 28L. In the DGU 86, text and/or graphic messages may be superimposed over the video NTSC signal (NTSC+).

If text and/or graphic messages are to be displayed on monitor 28R using the same row 10 example, then switches I and P are controlled closed instead of switches B and N. In this state, the NTSC video signal from camera 14 is passed through the DGU 86 in which text and/or graphic messages may be added to the video signal before being displayed on the monitor 28R. In the diagnostic mode, the video signal may be interrupted by the DGU 86 which replaces it with an appropriate menu screen for driver interaction via the user interface and smart switch 92B, for example. In this manner, the DGU 86 may add text and/or graphic messages to the video signal being conducted therethrough upon proper selection and control of the switches A-P in the switch matrix. The video image signal may be also interrupted by the DGU 86 and replaced by a menu selection screen for use as a diagnostic tool as described herein above in connection with the embodiment of FIG. 12.

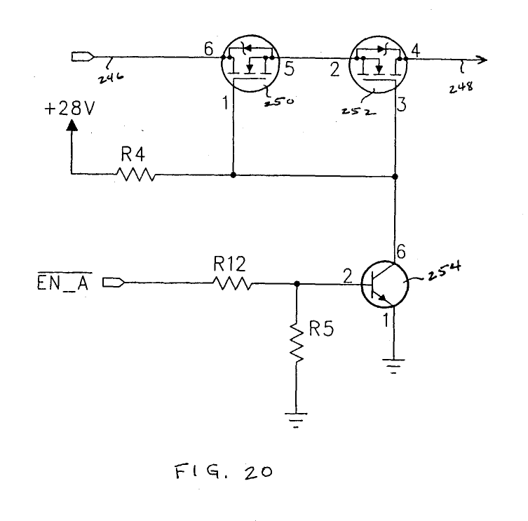

FIG. 23 is a block diagram schematic of another alternate embodiment of the embodiment described in connection with FIG. 19 herein above. The embodiment of FIG. 23 adds another display monitor 28C to the embodiment of FIG. 19, preferably in the center between the monitors 28L and 28R. Logic may be programmed into the controller 240 to use the center display 28C as a “rear mirror” in the cab of the vehicle, for example, unless messages received over the JBUSes indicate otherwise. Such an additional display is of value in the “park assist” and tight maneuvering scenarios discussed above. The embodiment of FIG. 23 employs the same basic system components as described for the embodiment of FIG. 19 and adds a third switch in parallel to each parallel pair of switches commonly coupled to the outputs of the buffer amplifiers 230, 232, 234, and 236. More specifically, switch Q has one side coupled to the output of amplifier 230, switch R has one side coupled to the output of amplifier 232, switch S has one side coupled to the output of amplifier 234, and switch T has one side coupled to the output of amplifier 236. The other sides of switches Q, R, S, and T are commonly coupled to the center monitor 28C through another buffer amplifier 256. Accordingly, all of the switches A-H and Q-T are controlled by the controller 240 to display a selected camera image on a selected monitor of the monitors 28L, 28C and 28R. This may be accomplished through a truth table similar to the table described in FIG. 21, for example, programmed into the controller 240.

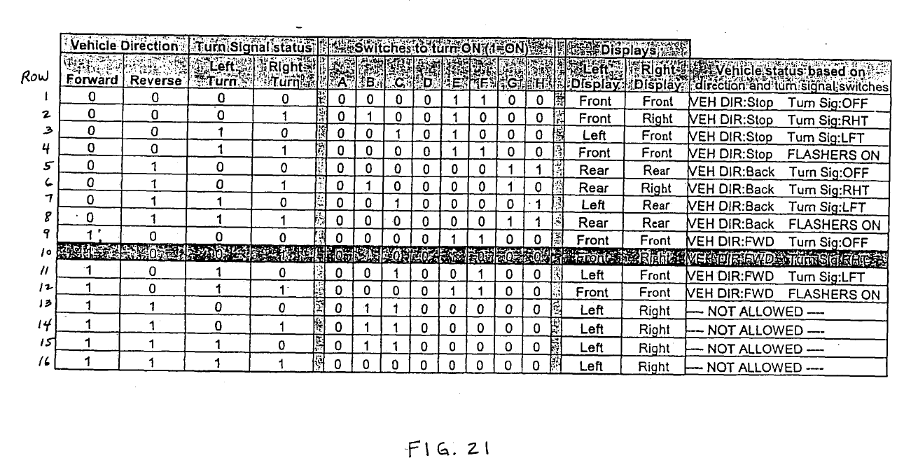

FIG. 24 is a block diagram schematic of an alternate embodiment of the embodiment described in connection with FIG. 23 herein above. Note that the embodiment of FIG. 24 is similar in circuit architecture to the embodiment described in connection with FIG. 22 which adds the DGU 86 and another smart switch 92B for user interface. Like components among the similar embodiments will retain their like reference numerals. In the embodiment of FIG. 24, another switch is added to each of the parallel switch configurations commonly coupled to the outputs of amplifiers 230, 232, 234 and 236. More specifically, switch U has one side coupled to the output of amplifier 230, switch V has one side coupled to the output of amplifier 232, switch W has one side coupled to the output of amplifier 234, and switch X has one side coupled to the output of amplifier 236. The other sides of switches U, V, w, and X are commonly coupled to the input of the DGU 86 which is coupled to the JBUSes to receive messages therefrom. Moreover, the other sides of switches Q, R, S and T are coupled through a switch Y to the input of amplifier 256 and the output of the DGU 86 is coupled through a switch Z to the input of amplifier 256. Switches Y and Z accommodate the use of the third display 28C with the DGU. The embodiment of FIG. 24 will operate in a similar manner to that described for the operation of the embodiment of FIG. 22, except that the embodiment of FIG. 24 has an additional monitor 28C on which to display an image and text/graphic.

Since the DGU 86 may accommodate a video/audio recording device, like a VCR, for example, an EVENT could be detected by the DGU 86 or controller 240 from the messages received over the JBUS links, for example, and a VCR 260 could be controlled to RECORD and STOP during critical situations by the controller 240, for example. In the present embodiment as shown in FIG. 24, the controller 240 may be programmed to detect the event or events from the messages received over the JBUS links and control the switch matrix to pass the NTSC image signal from a selected camera to the DGU 86. The selected image signal is passed through the DGU 86 and coupled to the VCR 260 through another switch 262 also controlled by the controller 240. This additional feature will provide flexibility for configuring the system on-the-fly.

It is understood that the switches of the foregoing described embodiments of FIGS. 22 through 24 may be all of the design described in connection with FIG. 20, for example, and controlled individually by the controller 240 via corresponding output digital ports as is well known to all those skilled in the pertinent art. Moreover, while only four camera to two and three display monitor configurations were described for the embodiments of FIGS. 19, 22, 23 and 24, it is further understood that these configurations were presented merely by way of example and that other possible camera to display monitor configurations are considered within the scope of this aspect of the present invention. In addition, in the embodiments described herein above, certain system components were described as separate circuit units, e.g. the DGU 86, smart switch 92 and controller 240. However, it is further understood that these system components may be combined into one or more single electronic components embodying the combined functions of the separate system components without deviating from the broad principles of the present invention.

There are many “over-the-counter” devices on the market today to provide the functions of a user interface or operator interaction suitable for use with a smart switch device such as described above in connection with the embodiment of FIG. 7. Integral embedded keypads are used routinely for entering user information and for cursor control text selection and menu navigation which may be the case for the present embodiments. However, these embedded or built-in keypads typically offer a limited number of keys and add cost to the system since they are designed as part of the product offering. Thus, use of a standard keyboard, like an IBM PC keyboard, AT style, for example, is preferable.

So, in accordance with yet another aspect of the present invention, an interface is provided for interfacing the standard keyboard to a smart switch device for deciphering or converting the keyboard scan code of characters into messages which may be transmitted over one of the JBUSes, like the J1587 bus, for example, to an listening device, like the DGU, for example, which may perform an editing function on the received character messages. The interface unit may include a message ID selection mechanism to accommodate multiple target/listening devices communicating over the JBUSes on the vehicle.

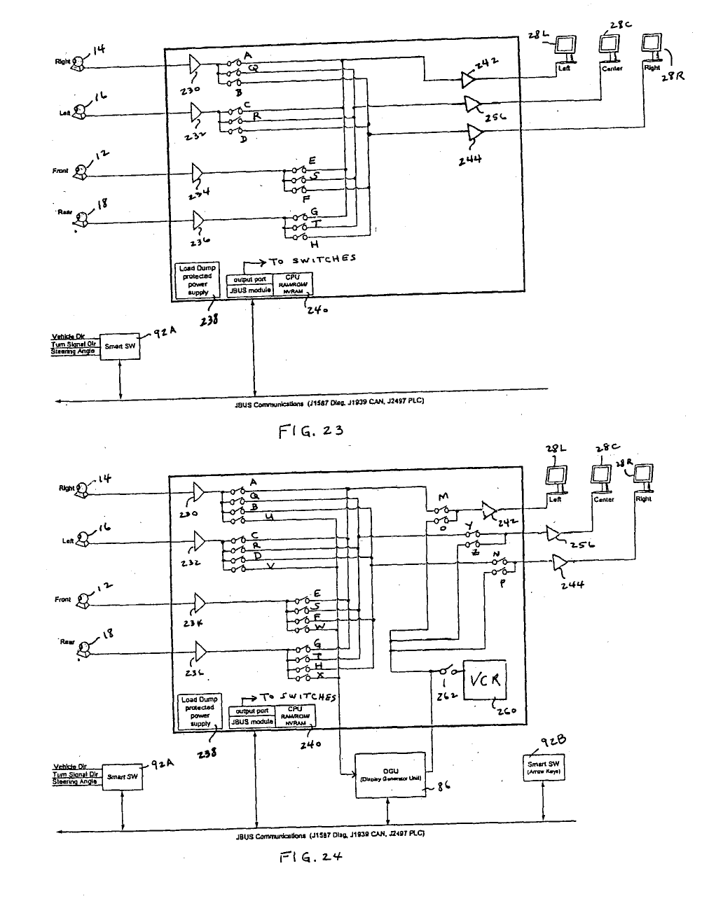

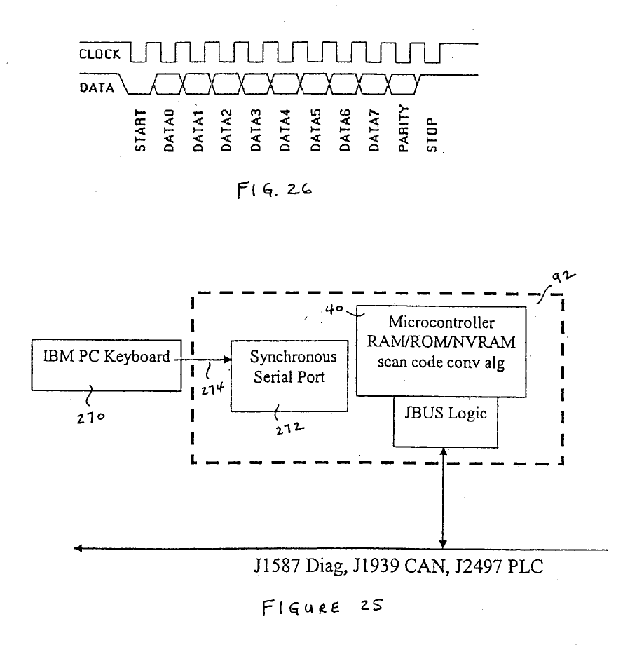

FIG. 25 is block diagram schematic of an exemplary keyboard user interface unit suitable for use in the embodiments of the present invention as described herein above. FIG. 26 illustrates typical clock and data signals of a character output from an IBM PC keyboard in accordance with the present embodiment. Referring to FIG. 25, an IBM PC keyboard 270 of the AT style, for example, is coupled over signal lines 274 to a synchronous serial port 272 which may be part of the microcontroller unit 40 in the smart switch 92. The microcontroller 40 is coupled to the JBUSes of the vehicle through a JBUS logic unit similar to that described in connection with the embodiment of FIG. 7, for example. The signal lines 274 may comprise a data line and a clock line. As shown in FIG. 26, in the present embodiment, a character is transmitted by the keyboard in an eleven bit frame of serial code comprising eight data bits along with parity (odd), start and stop bits. The microcontroller 40 may be programmed to read in each character frame through the port 272 synchronously controlled by the keyboard clock and to decipher each frame of code into its corresponding character.

Once deciphered, the microcontroller 40 is further programmed to convert each converted character into a transmittable message which is transmitted via the JBUS logic over an appropriate JBUS link, like the J1587 bus, per the J1587 bus protocol, for example. A listening device, like the DGU 86, for example, receives the messages from the appropriate JBUS as described herein above and performs an editing function thereof under program control. If the DGU 86 is in the diagnostic mode, the operator may use the keyboard 270 which may be located convenient to the driver in the cab of the vehicle, for example, as a user interface for menu navigation, text selection, parameter entry and the like, for example, as described in connection with the various embodiments presented herein above.

Accordingly, the present invention should in no way be limited to any of the foregoing described embodiments which are presented by way of example, but rather construed in breadth and broad scope in accordance with the recitation of the claims appended hereto.

We claim:

1. An integrated video/data information system for use on-board a commercial vehicle, said system comprising:
a digital integrated data bus for conveying among bus modules coupled to said bus video and data information in a digital format based on a predetermined bus protocol;
a plurality of bus compatible camera modules coupled to said integrated data bus, each camera module of said plurality comprising a camera for generating image data representative of a view thereof, each camera module operative as a bus module for transmitting, upon command, over said bus said image data in a digital format compatible with said predetermined bus protocol;
at least one bus compatible display module coupled to said integrated data bus, each display module comprising a display monitor for displaying image data for viewing by an operator, each display module operative as a bus module to receive from said bus, upon command, image data originating from a selected camera module of said plurality, and to display said image data on said display monitor thereof; and
a bus master module coupled to said integrated data bus for transmitting commands over said bus to said plurality of camera modules and said at least one display module, said commands comprising a first command for directing a selected camera module of said plurality to transmit image data thereof over said bus, and a second command for directing a selected display module of said at least one display module to receive image data corresponding to said selected camera module from said bus and to display said received image data on said display monitor thereof.

2. The system of claim 1 wherein the plurality of bus compatible camera modules comprises at least one integrated bus compatible camera coupled to the bus and responsive to a first command to transmit compressed digital video data over the bus in a format compatible with the predetermined bus protocol, said compressed digital video data being representative of an NTSC image signal generated by the camera.

3. The system of claim 1 wherein the plurality of bus compatible camera modules comprises at least one camera module including: a camera for generating an NTSC image signal representative of view thereof, and a bus compatible converter circuit coupled between said camera and the integrated data bus for converting said NTSC image signal into compressed digital video data, said converter circuit operative as a bus module to transmit, upon command, said compressed digital video data over the bus in a format compatible with the predetermined bus protocol.

4. The system of claim 1 wherein the plurality of bus compatible camera modules comprises at least one camera module including: a camera for generating an NTSC image signal representative of view thereof and transmitting said image signal wirelessly; a receiver for receiving said transmitted image signal; and a bus compatible converter circuit coupled between said receiver and the integrated data bus for converting said NTSC image signal into compressed digital video data, said converter circuit operative as a bus module to transmit, upon command, said compressed digital video data over the bus in a format compatible with the predetermined bus protocol.

5. The system of claim 1 wherein the plurality of bus compatible camera modules comprises at least one camera module including: a video camera for generating an NTSC image signal representative of view thereof.

6. The system of claim 1 wherein the plurality of bus compatible camera modules comprises at least one camera module including: a night vision camera for generating an NTSC infrared image signal representative of view thereof.

7. The system of claim 1 wherein the at least one bus compatible display module comprises at least one integrated bus compatible display monitor coupled to the bus and responsive to the second command to receive from the bus compressed digital video data originating from a selected camera module and to convert said received compressed digital video data into a representative NTSC image signal which is displayed on the display monitor thereof.

8. The system of claim 1 wherein the at least bus compatible display module comprises at least one display module including: a display monitor for displaying an NTSC image signal; and a bus compatible converter circuit coupled between said display monitor and the integrated data bus, said converter circuit operative as a bus module to receive from the bus, upon command, compressed digital video data originating from a selected camera module and converting said received compressed digital video data into a representative NTSC image signal which is passed to said display monitor for display.

9. The system of claim 1 wherein the plurality of bus compatible camera modules comprises a camera module for generating an image signal representative of a front view from the vehicle.

10. The system of claim 1 wherein the plurality of bus compatible camera modules comprises a camera module for generating an image signal representative of a side view from the vehicle.

11. The system of claim 1 wherein the plurality of bus compatible camera modules comprises a camera module for generating an image signal representative of a rear view from the vehicle.

12. The system of claim 1 wherein the bus master module is operative to receive data signals representative of an operational status of the vehicle and to transmit the first and second commands over the bus based on said received data signals.

13. The system of claim 12 wherein the received data signals comprise data signals representative of the turning status and directional movement of the vehicle.

14. The system of claim 13 wherein the turning status data signals and the directional movement data signals are coupled directly to the bus master module through a digital input port thereof.

15. The system of claim 12 wherein the vehicle includes at least one existing communication bus; and including: a communication bus module operative to receive data signals representative of an operational status of the vehicle, to convert the data signals into communication bus compatible messages, and to transmit said data signal messages over said at least one existing communication bus; and a gateway module coupled to said at least one communication bus and operative to receive said data signal messages from said at least one communication bus, said gateway module coupled to the bus master module for passing said data signals to said bus master module for use therein.

16. The system of claim 12 wherein the bus master module is operative to transmit the first and second commands over the bus in accordance with a look-up table based on predetermined camera image-to-display monitor combinations correlated to the operational status of the vehicle represented by the data signals.

17. The system of claim 1 including a recording module coupled to the bus for recoding, upon command, image and operational data, received from the bus, on respectively designated channels on a recording media thereof in a real time synchronized format.

18. The system of claim 17 wherein the bus master module is operative to transmit a third command over the bus to the recording module; and wherein the recording module is responsive to said third command received from the bus to start recording for a predetermined time period.

19. The system of claim 18 wherein the bus master module is operative to transmit the third command over the bus to the recording module in response to an event signal.

20. The system of claim 17 wherein the vehicle includes at least one existing communication bus for conveying among communication bus modules operational data of the vehicle; and including a gateway module coupled to said at least one communication bus and operative to receive said operational data from said at least one communication bus, said gateway module also coupled to the integrated data bus and operative as an integrated data bus module for transmitting said operational data received from the at least one communication bus over the integrated data bus.

21. The system of claim 17 including a retrieval module coupleable to the recording module for retrieving and displaying recorded image and operational data for analysis.

22. The system of claim 21 wherein the retrieval module comprises a personal computer.

23. The system of claim 1 including a text overlay module coupled to a display module for overlaying text messages onto image data for display on the display monitor of said display module.

24. The system of claim 23 wherein the text overlay module is operative to overlay graphic messages onto image data for display on the display monitor of said display module.

25. The system of claim 23 wherein the vehicle includes at least one existing communication bus for conveying among communication bus modules operational data of the vehicle; and wherein the text overlay module includes a bus interface circuit coupled to said at least one communication bus and operative to receive said operational data from said at least one communication bus, the text overlay module operative to overlay onto image data for display text messages representative of selected operational data received from said communication bus.

26. The system of claim 25 wherein the text overlay module includes a memory for storing text messages corresponding to fault conditions of the vehicle; wherein the communication bus also conveys data representative of fault conditions of the vehicle which is received by the text overlay module through the bus interface circuit thereof; and wherein the text overlay module is operative in response to received fault condition data to access corresponding text messages from said memory and to display said text messages on the display monitor.

27. The system of claim 26 including a bus communication module coupled to the communication bus and responsive to interactive display commands from a user interface to transmit said commands over the communication bus; wherein the text overlay module is operative to receive said commands from the communication bus through the bus interface circuit thereof and to select text messages to display on the display monitor in response to said commands.

28. The system of claim 26 including a bus communication module coupled to the communication bus and including an interface circuit for receiving signals from sensors on-board the vehicle, said bus communications module operative to determine fault conditions from said received sensor signals and to transmit said fault conditions over the communication bus.

29. The system of claim 1 including a configuration module coupled to the integrated data bus and operative as a user interface for system configuration, said configuration module for transmitting system configuration information to the bus master module.

30. The system of claim 1 wherein the bus master module is operative to transmit first commands over the integrated data bus for directing a plurality of selected camera modules to transmit simultaneously image data over said bus, and to transmit second commands over the integrated data bus for directing a plurality of selected display modules to receive simultaneously image data from said bus, each selected display module directed to receive image data from a corresponding selected camera module of said plurality.

31. The system of claim 1 wherein the integrated data bus is based on an IEEE-1394 bus standard.

32. A text overlay module disposeable on-board a commercial vehicle and coupleable between a display monitor and at least one existing communication bus of said vehicle for overlaying text messages onto image data for display on said display monitor, said module comprising:
a bus interface circuit coupled to said at least one communication bus for receiving vehicle data representative of fault conditions and operational measurement and status data from the at least one communication bus;
a microcontroller coupled to said bus interface circuit and operative to respond to said received fault condition and operational data;
a memory for storing text messages corresponding to fault conditions and operational
said microcontroller responsive to fault condition and operational data received from the at least one communication bus to access corresponding text messages from said memory and to overlay said text messages onto image data for display on said display monitor.

33. The module of claim 32 wherein the vehicle includes at least one camera for generating image data representative of a camera view for display on the display monitor; and wherein the module is disposed between the camera and display monitor for overlaying text messages onto image data of said camera for display on the display monitor.

34. A communication bus module operative to communicate alarm and operational data over at least one existing communication bus on-board a commercial vehicle, said module comprising:
a bus interface circuit coupled to said at least one communication bus for transmitting alarm and operational data over the at least one communication bus;
a microcontroller coupled to said bus interface circuit and operative to control the transmission of alarm and operational data over the at least one communication bus;
a first interface circuit coupled to said microcontroller for receiving data signals representative of an operational status of the vehicle and for passing said operational status data to said microcontroller;
a second interface circuit coupled to said microcontroller for receiving and digitizing sensor signals from a plurality of on-board vehicle sensors operative to measure parameters of the vehicle and for passing said digitized sensor signals to said microcontroller;
a memory for storing thresholds corresponding to said sensor signals, said thresholds being based on the vehicle parameter being measured by the corresponding sensor;
said microcontroller operative to convert said operational status data into first bus messages and to control the transmission of said first bus messages over the at least one communication bus; and
said microcontroller further operative to generate data representative of alarm conditions determined from the digitized sensor signals and their corresponding thresholds, to convert said alarm condition data into second bus messages and to control the transmission of said second bus messages over the at least one communication bus.

35. A diagnostic system for use on a commercial vehicle utilizing an at least one existing on-board communication bus and an existing on-board vision system including a camera for generating image data representative of a view thereof, and a display monitor for displaying said camera image data on a screen thereof, said vehicle including a plurality of electronic control units (ECUs) for monitoring the fault status of corresponding resources, said plurality of ECUs being coupled to said at least one communication bus for conveying fault condition and diagnostic data thereover, said system comprising:
a display generator unit including:
a microcontroller;
a bus interface circuit coupled between said microcontroller and the at least one communication bus for receiving fault condition and diagnostic data from the communication bus and passing said received data to said microcontroller;
a text overlay circuit coupled between the camera and display monitor and governed by said microcontroller for overlaying text messages onto the image data of the camera to form composite image data and for transmitting said composite image data to the display monitor for display thereon; and
a memory coupled to said microcontroller for storing text messages and text menu screens corresponding to said fault conditions; and
a communication bus module coupled to the at least one communication bus for receiving display command signals from a user interface and transmitting said display command signals over the at least one communication bus, said display command signals being received by the bus interface circuit and passed to the microcontroller for use in controlling the display of text messages and text menu screens on the display monitor.

36. The diagnostic system of claim 35 wherein the microcontroller is responsive to fault condition data from an ECU of said plurality received from the at least one communication bus to access a corresponding text message from the memory, said microcontroller operative to control said text overlay circuit to overlay said accessed text message onto the camera image data to form composite image data for display on the display monitor.

37. The diagnostic system of claim 36 wherein the microcontroller is responsive to a first display command, focused on the displayed ECU fault text message, received over the at least one communication bus to access data representative of an ECU text menu screen from the memory, said microcontroller operative to control said text overlay circuit to pass said accessed ECU text menu screen data to the display monitor for display thereon.

38. The diagnostic system of claim 37 wherein the microcontroller is responsive to a second display command, selecting the faulted ECU from the displayed ECU text menu screen, received over the at least one communication bus to interact with the faulted ECU over the at least one communication bus to determine the fault condition of the ECU.

39. The diagnostic system of claim 38 wherein the microcontroller is operative to access a text message corresponding to the determined ECU fault condition from the memory, said microcontroller operative to control said text overlay circuit to pass said accessed ECU fault condition text message to the display monitor for display thereon.

40. The diagnostic system of claim 38 the microcontroller interacts with the faulted ECU over the at least one communication bus-by transmitting an interrogation signal over the at least one communication bus via the bus interface circuit to the faulted ECU requesting the fault condition thereof; wherein the faulted ECU is responsive to said interrogation signal to transmit data representative of the fault condition back over the at least one communication bus to the microcontroller via the bus interface circuit.

41. A bus compatible converter circuit coupled between an integrated data bus having a predetermined bus protocol and a camera for generating an NTSC image signal representative of a view thereof, said converter circuit comprising:
a first circuit coupled to said camera for converting said NTSC image signal into compressed digital video data representative thereof;
a second circuit coupled between said first circuit and said bus for transmitting said compressed digital video data over said bus in a format compatible with said predetermined bus protocol; and
a controller coupled to said first and second circuits for coordinating the operations of said first and second circuits.

42. The bus compatible converter circuit of claim 41 wherein the first circuit comprises a CODEC integrated circuit.

43. The bus compatible converter circuit of claim 41 wherein the second circuit comprises a data link layer circuit and a physical layer circuit.

44. The bus compatible converter circuit of claim 41 wherein the controller comprises a programmed CPU.

45. A bus compatible converter circuit coupled between an integrated data bus having a predetermined bus protocol and a display monitor for displaying an NTSC image signal on a screen thereof, said converter circuit comprising:
a first circuit coupled to said bus for receiving from said bus compressed digital video data representative of said NTSC image signal and in a format compatible with said predetermined bus protocol;
a second circuit coupled between said first circuit and said display monitor for converting said compressed digital video data into the NTSC image signal representative thereof for display on said monitor screen; and
a controller coupled to said first and second circuits for coordinating the operations of said first and second circuits.

46. The bus compatible converter circuit of claim 45 wherein the second circuit comprises a CODEC integrated circuit.

47. The bus compatible converter circuit of claim 45 wherein the first circuit comprises a data link layer circuit and a physical layer circuit.

48. The bus compatible converter circuit of claim 45 wherein the controller comprises a programmed CPU.

49. An integrated video/data information system for use on-board a commercial vehicle including at least one existing communication bus, said system comprising:
a plurality of cameras, each camera for generating an image signal representative of a view thereof;
a plurality of display monitors, each display monitor for displaying a camera generated image signal for viewing by an operator;
a matrix of switches disposed between said plurality of cameras and said plurality of display monitors;
a switch controller coupled to said matrix of switches for controlling said switches to connect the image signal from at least one camera to at least one display monitor for display on a viewing screen thereof, said switch controller being coupled to said at least one communication bus for receiving data therefrom; and
a bus communication module coupled to said at least one communication bus, said module operative to receive data signals representative of an operational status of the vehicle and to transmit said operational status data over the at least one communication bus, said switch controller operative to receive the operational status data from the at least one communication bus and to control the switches of said matrix based on said operational status data.

50. The system of claim 49 wherein the matrix of switches comprises a switch coupled between each camera of the plurality and each display monitor of said plurality.

51. The system of claim 49 including a buffer amplifier coupled between each camera of the plurality and the matrix of switches.

52. The system of claim 49 including a buffer amplifier coupled between each display monitor and the matrix of switches.

53. The system of claim 49 including a display generator unit coupled to the communication bus and matrix of switches; and wherein the switch controller is operative to control the switches of the switch matrix to connect said display generator unit between a selected camera image signal and a selected display monitor.

54. The system of claim 53 wherein the matrix of switches comprises: a first switch coupled between each camera of the plurality and each display monitor of said plurality; a second switch coupled between each camera of the plurality and the display generator unit; a third switch coupled between the first switches and each display monitor of the plurality; and a fourth switch coupled between each display monitor of the plurality and the display generator unit.

55. The system of claim 53 wherein the display generator unit is operative to overlay text messages onto the selected camera image signal to form a composite text/image signal for display on the selected display monitor.

56. The system of claim 53 including another communication bus module coupled between a user interface and the at least one communication bus for receiving display command signals from the user interface and transmitting said display command signals over the at least one communication bus; and wherein the display generator unit operative to receive said display command signals from the at least one communication bus to govern the display of text messages to the selected display monitor.

57. The system of claim 49 wherein the switch controller is operative to receive the operational status data from the at least one communication bus and to control the switches of said matrix in accordance with a look-up table based on predetermined camera image-to-display monitor combinations correlated to the operational status data.

58. The system of claim 57 wherein the operational status data comprises data representative of the turning status and directional movement of the vehicle.

59. The system of claim 49 wherein the switch matrix comprises solid-state switches.

60. The system of claim 49 including a recording unit coupled to the switch matrix for recording a selected camera image signal.

61. A keyboard user interface for use on-board a commercial vehicle for communicating over at least one existing communication bus of said vehicle, said interface comprising:
a keyboard comprising a multiplicity of character keys for selection by a user and for generating a coded digital word representative of a user selected character key thereof; and
a communication interface circuit coupled between said keyboard and the at least one communication bus, said communication interface circuit operative to receive said coded digital word, to convert the received coded digital word into a character message compatible with the at least one communication bus, and to transmit said character message over the at least one communication bus of the vehicle.

62. The interface of claim 61 wherein the communication interface circuit comprises:
a digital input port coupled to the keyboard;
a microcontroller coupled to the digital input port for receiving the coded digital word from the keyboard and converting the coded digital word into the character message compatible with the at least one communication bus; and
a bus interface circuit coupled between the at least one communication bus and said microcontroller for transmitting the character message over the at least one communication bus of the vehicle.

63. The interface of claim 62 wherein the coded digital word is transmitted bit serial from the keyboard to the digital input port.

64. The interface of claim 63 wherein the keyboard transmits a synchronizing clock signal together with the bit serial coded digital word; and wherein the digital input port comprises a synchronous serial port governed by the synchronizing clock signal to receive the bit serial coded digital word.

65. The interface of claim 62 wherein the at least one communication bus operates in accordance with a predetermined bus protocol; wherein the microcontroller is operative to convert the coded digital word into the character message in a format compatible with said predetermined bus protocol of the at least one communication bus; and wherein the bus interface circuit is operative to transmit the character message over the at least one communication bus of the vehicle in accordance with said predetermined bus protocol.

66. A method of communicating integrated video/data information on-board a commercial vehicle, said method comprising the steps of:
generating from each of a plurality of bus compatible camera modules image data representative of a corresponding view thereof;
transmitting a first command over a digital integrated data bus to a selected camera module of said plurality to direct said selected camera module to transmit image data over said data bus in a digital format compatible with a predetermined bus protocol;
transmitting a second command over said digital integrated data bus to a bus compatible display module to direct said display module to receive from said data bus in accordance with said predetermined bus protocol said digitally formatted image data originating from said selected camera module and to display said image data; and
transmitting said first and second commands based on an operational status of said commercial vehicle.

67. The method of claim 66 wherein the step of transmitting the first and second commands is based on a turning status and directional movement of the commercial vehicle.

68. The method of claim 66 wherein the step of transmitting the first and second commands includes transmitting the first and second commands in accordance with a look-up table based on predetermined camera image-to-display module combinations correlated to the operational status of the vehicle.

69. The method of claim 66 including the steps of: transmitting data representative of the operational status of the commercial vehicle over at least one pre-existing communication bus of the commercial vehicle; and receiving said operational data from the at least one pre-existing communication bus for use in transmitting the first and second commands.

70. The method of claim 66 including the step of transmitting a third command over the digital integrated data bus to a bus compatible recording module to direct said recording module to receive from said data bus in accordance with said predetermined bus protocol said digitally formatted image data originating from said selected camera module and to record said image data for a predetermined time period.

71. The method of claim 70 wherein the third command is transmitted in response to an event signal.

72. The method of claim 70 including the step of transmitting operational data of the commercial vehicle over the integrated data bus in digital format compatible with the predetermined bus protocol; and wherein the step of transmitting the third command includes transmitting the third command over the digital integrated data bus to the bus compatible recording module to direct the recording module to receive from the data bus in accordance with the predetermined bus protocol the digitally formatted image data originating from the selected camera module and operational data, and to record the received image and operational data in a real time synchronized format.

73. The method of claim 66 including the step of overlaying text messages onto image data for display by the display module.

74. The method of claim 73 including the steps of: transmitting data representative of operational status of the commercial vehicle over at least one pre-existing communication bus of the commercial vehicle; receiving operational data from the at least one pre-existing communication bus; and overlaying text messages representative of the operational data onto the image data in response to said received operational data.

75. The method of claim 73 including the steps of: transmitting data representative of fault conditions of the commercial vehicle over at least one pre-existing communication bus of the commercial vehicle; receiving fault condition data from the at least one pre-existing communication bus; and overlaying text messages representative of said fault conditions onto the image data in response to said received fault condition data.

76. The method of claim 73 including the steps of: transmitting user display commands over at least one pre-existing communication bus of the commercial vehicle; receiving the user display commands from the at least one pre-existing communication bus; and controlling the display of the display module in response to said received display commands.

77. The method of claim 66 wherein the step of transmitting a first command includes transmitting first commands over the integrated data bus to a plurality of selected camera modules to direct said selected camera modules to transmit simultaneously image data over said data bus, and wherein the step of transmitting a second command includes transmitting second commands over the integrated data bus to a plurality of selected display modules to direct said selected display modules to receive simultaneously image data from said bus data, each selected display module directed to receive image data from a corresponding selected camera module of said plurality.
